(19) United States
(12) Patent Application Publication
(10) Pub. No.: US 2020/0097799 A1
(43) Pub. Date: Mar. 26, 2020

(54) HETEROGENEOUS MULTIPLIER

(71) Applicant: Intel Corporation, Santa Clara, CA (US)

(72) Inventors: Dilin Divakar, Bangalore (IN); Ambili Vengallur, Bangalore (IN); Ajit Singh, Bangalore (IN)

(73) Assignee: Intel Corporation, Santa Clara, CA (US)

(21) Appl. No.: 16/619,062

(22) PCT Filed: Jun. 30, 2017
(86) PCT No.: PCT/US2017/040164

§ 371 Date: Dec. 3, 2019

(51) Int. Cl. G06N 3/04; G06N 3/063; G06N 3/08; G06F 7/523

(52) U.S. Cl. CPC G06N 3/0454; G06N 3/063; G06F 2207/3824; G06F 7/523; G06N 3/08

(57) ABSTRACT

Heterogeneous multiplier circuitry is provided with an interface to a configuration register to access configuration information, where the configuration information identifies respective data formats of a first operand and a second operand to be used in a first multiplication operation, where the first operand is in a first data format including a first numerical representation and the second operand is in a different, second data format including a different, second numerical representation. The heterogeneous multiplier circuitry includes an operand modifier to modify the second operand to generate a modified second operand, and further includes a multiplier to perform multiplication of the first operand and the modified second operand to generate a result in the first data format.

### TECHNICAL FIELD

This disclosure relates in general to the field of computing systems and, more particularly, to arithmetic circuitry within computing systems.

### BACKGROUND

Multiprocessor systems are becoming more and more common. Applications of multiprocessor systems include dynamic domain partitioning all the way down to desktop computing. In order to take advantage of multiprocessor systems, code to be executed may be separated into multiple threads for execution by various processing entities. Each thread may be executed in parallel with one another.

A convolutional neural network (CNN) is a computational model, recently gaining popularity due to its power in solving human-computer interface problems such as image understanding. The core of the model is a multi-staged algorithm that takes, as input, a large range of input samples (e.g., image pixels) and applies a set of transformations to the inputs in accordance with predefined functions. The transformed data may be fed into a neural network to detect patterns.

### BRIEF DESCRIPTION OF THE DRAWINGS

FIG. 1 is a simplified schematic diagram of an example system including a computing system enhanced to perform machine learning tasks in accordance with one embodiment;

FIG. 2 is a simplified block diagram of a computing device to include one or more instances of heterogeneous multiplier circuitry in accordance with one embodiment;

FIG. 3 is a simplified block diagram of example heterogeneous multiplier circuitry in accordance with one embodiment;

FIGS. 4A-4D are simplified block diagram representing example multiplication operations to be performed by example heterogeneous multiplier circuitry;

FIG. 5A is a simplified block diagram representing an example convolutional neural network (CNN) in accordance with one embodiment;

FIG. 5B is a simplified block diagram representing an example convolution operation in accordance with one embodiment;

FIG. 6 is a simplified block diagram representing the dynamic configuration of example heterogeneous multiplier circuitry in connection with a definition of an example CNN, in accordance with one embodiment;

FIG. 7 is a simplified block diagram representing an example multiply-accumulate (MAC) unit incorporating example heterogeneous multiplier circuitry, in accordance with one embodiment;

FIGS. 8A-8B are simplified flow charts showing example techniques utilizing example heterogeneous multiplier circuitry;

FIG. 9 is a block diagram of a register architecture according to one embodiment;

FIG. 10A is a block diagram illustrating both an exemplary in-order pipeline and an exemplary register renaming, out-of-order issue/execution pipeline according to at least some embodiments;

FIG. 10B is a block diagram illustrating both an exemplary embodiment of an in-order architecture core and an exemplary register renaming, out-of-order issue/execution architecture core to be included in a processor according to at least some embodiments;

FIG. 11A-11B illustrate a block diagram of a more specific exemplary in-order core architecture, which core would be one of several logic blocks (including other cores of the same type and/or different types) in a chip;

FIG. 12 is a block diagram of a processor that may have more than one core, may have an integrated memory controller, and may have integrated graphics according to at least some embodiments;

FIGS. 13-16 are block diagrams of exemplary computer architectures; and

FIG. 17 is a block diagram contrasting the use of a software instruction converter to convert binary instructions in a source instruction set to binary instructions in a target instruction set according to at least some embodiments.

Like reference numbers and designations in the various drawings indicate like elements.

### DETAILED DESCRIPTION OF EXAMPLE EMBODIMENTS

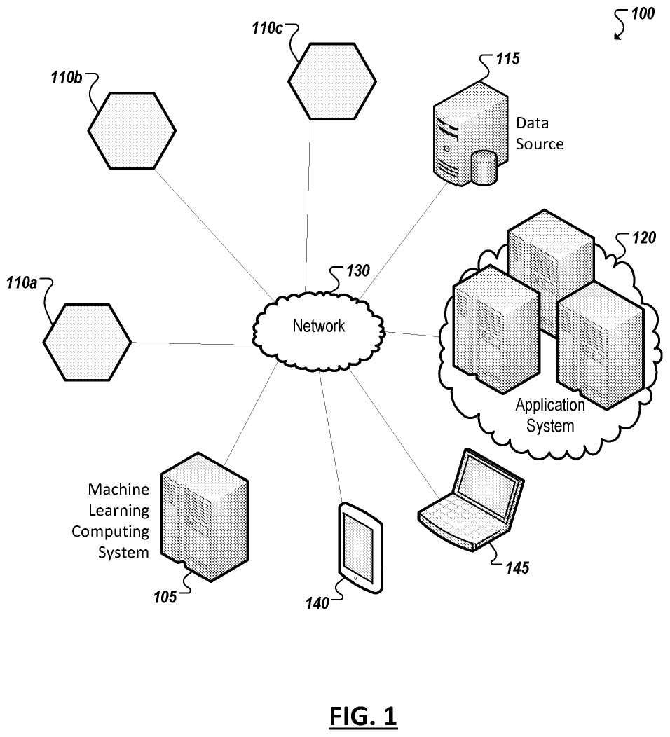

FIG. 1 illustrates an example computing system including a machine learning computing system 105, which may accept as inputs, data from one or a variety of sources. For instance, sources may include sensor devices (e.g., 110a-c). Such devices 110a-c may detect and/or measure attributes of an environment and generate sensor data describing or capturing characteristics of the environment. For instance, a given sensor may be configured to detect such characteristics as movement, weight, physical contact, temperature, wind, noise, light, computer communications, wireless signals, humidity, the presence of radiation or specific chemical compounds, among several other examples. Sensors may generate numerical data describing these attributes, audio data, photographic images, video, among other sensor data. Sources may additionally include data stores, such as databases of one or more computing systems (e.g., 115), which may aggregate data and/or generate additional data (e.g., from post processing of the aggregated data), such as in connection with a governmental, enterprise, scientific, or other entity or project. Data from the one or more sources (e.g., 110a-c, 115, etc.) may be provided to the machine learning computing system 105 to perform machine and deep learning on the information encapsulated in the data. In some implementations, the machine learning computing system 105 may make use of one or more artificial neural networks (ANN) to process data generated by sensors (e.g., 110a-c) and other data sources. An artificial neural network may be implemented as one or more of a convolutional neural network (CNN), spiking neural network (SNN), convolutional spiking neural network (CSNN), feedforward neural network (FNN), recurrent neural network (RNN), among other examples and machine learning algorithms and models. In some implementations, an example machine learning computing system 105 may be implemented using hardware with functionality to enhance the performance of computing, memory, and data movement operations relating to machine learning applications. For instance, in some implementations, computing hardware of an example machine learning computing system may be equipped with a heterogeneous multiplier to flexibly handle operands in a variety of different data formats (e.g., as specified in various layers of a neural network). In some cases, such a heterogeneous multiplier device can be implemented in an example multiply-accumulate unit used to perform convolution operations, among other example components, functionality, and features.

Continuing with the example of FIG. 1, results produced by a machine learning computing system 105 may be additionally consumed by other systems, for instance, by an application system 120 hosting one or more other processes, programs, or applications. User endpoint devices (e.g., 140, 145), such as personal computers and mobile devices, may additionally make use of the results generated from or in connection with a machine learning computing system 105, such as through the consumption of the results by one or more applications hosted by the user devices (e.g., 140, 145), presenting the results on a graphical user interface of the user device, among other examples.

In some instances, as implied by the example illustrated in FIG. 1, a machine learning computing system 105 may be provided as a service (e.g., over a network 130) to one or more other systems (e.g., 120, 140, 145). A machine learning computing system 105 may additionally utilize inputs generated by remote systems (e.g., an Internet of Things (IoT) network composed of multiple sensor devices (e.g., 110a-c). In other instances, the functionality of a machine learning computing system 105 may be integrated with any one of the other example systems (e.g., 110a-c, 115, 120, 130, 140, 145, etc.). For instance, a wearable device or IoT device (e.g., 110a-c) may be provided with machine learning computing resources to operate directly on inputs generated by a sensor of the device. As another example, an application or service may be provided (e.g., by application server system 120), which includes and makes use of machine learning computing resources, among a variety of other examples and use cases. Further, machine learning computing systems may utilized to support or implement products or services based on or utilizing artificial intelligence, including digital personal assistants, chat bots, video games, self-driving cars, robots, and other examples.

In general, “servers,” “clients,” “computing devices,” “network elements,” “hosts,” “system-type system entities,” “user devices,” “sensor devices,” and “systems” (e.g., 105, 110a-c, 115, 120, 130, 140, 145, etc.) in example computing environment 100, can include electronic computing devices operable to receive, transmit, process, store, or manage data and information associated with the computing environment 100. As used in this document, the term “computer,” “processor,” “processor device,” or “processing device” is intended to encompass any suitable processing apparatus. For example, elements shown as single devices within the computing environment 100 may be implemented using a plurality of computing devices and processors, such as server pools including multiple server computers. Further, any, all, or some of the computing devices may be adapted to execute any operating system, including Linux, UNIX, Microsoft Windows, Apple OS, Apple iOS, Google Android, Windows Server, etc., as well as virtual machines adapted to virtualize execution of a particular operating system, including customized and proprietary operating systems.

While FIG. 1 is described as containing or being associated with a plurality of elements, not all elements illustrated within computing environment 100 of FIG. 1 may be utilized in each alternative implementation of the present disclosure. Additionally, one or more of the elements described in connection with the examples of FIG. 1 may be located external to computing environment 100, while in other instances, certain elements may be included within or as a portion of one or more of the other described elements, as well as other elements not described in the illustrated implementation. Further, certain elements illustrated in FIG. 1 may be combined with other components, as well as used for alternative or additional purposes in addition to those purposes described herein.

Deep learning based algorithms are utilized in several areas applying machine learning areas such as audio/video recognition, video summarization, among others. These workloads may be run on a variety of hardware platforms ranging from central processing units (CPUs) to graphics processing units (GPUs) and solution-specific hardware platforms built to handle particular predefined algorithms and data. Performance per watt is increasingly becoming a key differentiator in this area, driving the development of many custom hardware accelerators as well. These hardware blocks may employ several power saving techniques like compression, quantization, etc. in their bid to achieve optimal power per compute.

Algorithms employed to implement artificial neural networks have been found to tolerate some amount of noise in the data by design. This tolerance may be leveraged to save compute power and speed up hardware execution. Traditional approaches have focused on quantization of data, such as tensor flows supporting even 8 bit formats. Quantized resolution hardware accelerators may also be provided to optimize computations, although these typically support limited modes and operand data formats.

In some implementations, precision requirements may be different for feature maps and weights. In some cases, even lower precision on weights, compared to feature maps, may be permitted without drastically sacrificing overall accuracy of the neural network's performance. Additionally, permitting lower precision can help reduce the bandwidth requirement on weights, and can reduce associated memory storage requirements as well. Performing heterogeneous compute with sample (e.g., image) data in floating point format, and weights in lower precision and/or fixed-point data format is not natively supported in current hardware solutions. Instead, to implement systems that take advantage of lower precision, current solutions utilize software-based or out-of-band format conversions costing both performance and power. In some implementations, these and other example issues may be addressed through compute blocks composed of hardware to natively accept heterogeneous operand inputs (e.g., with one input (e.g., the sample) being floating point and/or higher precision and the other (e.g., weights/kernel) being lower precision/fixed point input) with minimal overhead. Such a solution can permit performance and power efficiencies, allow the reuse of hardware for multiple different types of arithmetic (to optimize compute area on the chip), and allow the design of improved neural networks that may be optimized based on the combinations of data formats used as inputs in the various layers of the network, among other example advantages.

Modern deep learning neural network topologies are revolutionizing fields, such as in machine-learning and audio/video recognition. The basic mathematical operation in at least some of the associated workloads may be a multiply-accumulate (MAC) operation. As noted above, heterogeneous arithmetic logic components, such as heterogeneous ALUs, MACs, multipliers, adders, etc. may be implemented (e.g., in a SIMD engine). For instance, in the example of a heterogeneous MAC, the multiplier and the accumulator can take inputs as either same number format or two different number formats. The current known solutions use same precision for both feature maps and weights due to lack of hardware support for heterogeneous arithmetic. Further, traditional software-based format conversions may add substantial latency, which may be unacceptable, for example, in machine learning applications, such as computer vision, autonomous vehicles, etc. where processing resources may not support such software and/or where low latency is important, among other example issues and considerations.

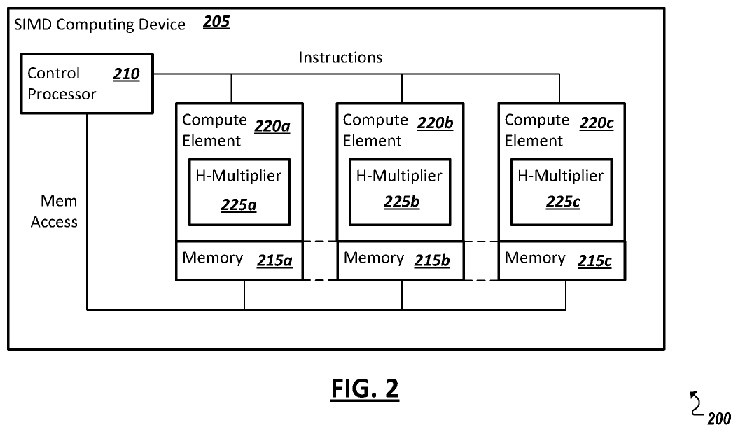

Turning to the example of FIG. 2, a simplified block diagram 200 is shown illustrating an example computing device 205, which may include instances of heterogeneous multiplier circuitry to assist in accommodating operands (e.g., multiplicands and multipliers) of differing data formats. For instance, the computing device 205 may be a system-on-chip, or processor device (e.g., a graphics processing unit, neuromorphic computing processor, central processing unit, among other examples). In this example, the computing device 205 may include a control processor 210 to orchestrate the performance of various operations on various data (e.g., samples and kernels) stored in one or more memory elements (e.g., 215a-c). The controller 210 may issue instructions to one or more compute elements 220a-220c provided on the computing device to perform operations on the data extracted from memory 215a-c. For instance, each of the compute elements 220a-220c may include arithmetic logic, implemented in hardware circuitry, to perform operations on the data. As an example, heterogeneous multiplier circuitry 225a-225c may be provided on each of the compute elements 220a-220c.

Each heterogeneous multiplier (e.g., 225a-225c) may be implemented to accept operands of heterogeneous data formats. Operands, which may be handled, and multiplied, using the heterogeneous multiplier may be of heterogeneous data formats. In other words, operands of heterogeneous data formats, as retrieved by memory 215a-215c, may be provided directly to the heterogeneous multiplier to be operated upon without prior conversion by software, the compute elements (e.g., 220a-220c), or other components of the corresponding computing system 205. The product computed by the heterogeneous multiplier 225a-225c may be in one of the two data formats of the operands and may be provided for storage in memory (e.g., 215a-215c) or for further computations using one or more other logical components of the compute elements (e.g., 220a-220c). As an example, in implementations where compute elements (e.g., 220a-220c) include or implement a MAC unit, the product of the heterogeneous multiplier may be provided to an adder and/or register (e.g., in a register or flop stage), such as in a convolution calculation, among other example implementations. The result computed by the compute element(s) (e.g., using its heterogeneous multiplier), may be stored in memory (e.g., 215-215c) and may be further accessed or passed to the same or a different one of the compute elements to perform additional operations. In one example, the output of the compute element (based on a multiplication operation performed by its heterogeneous multiplier circuitry) may be provided as an input of another calculation (e.g., another convolution) corresponding to another layer in a neural network, among other example use cases.

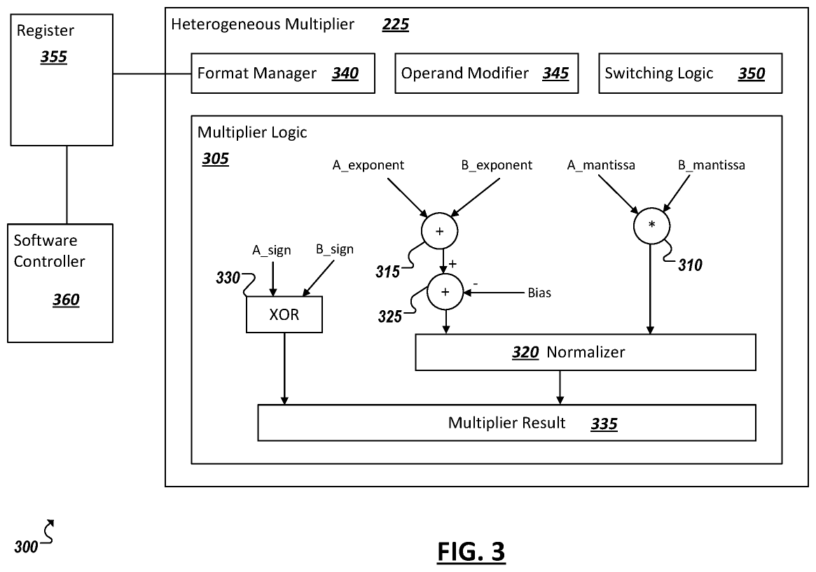

Turning to the example of FIG. 3, a simplified block diagram 300 is shown illustrating an example implementation of a heterogeneous multiplier 225. In one example, the heterogeneous multiplier 225 may be implemented as an augmented floating point multiplier. For instance, the heterogeneous multiplier 225 may include a mantissa multiplier circuit 310 to accept, as inputs, two mantissas. The heterogeneous multiplier 225 may additionally include an adder circuitry 315 to compute the sum of two exponent values associated with the mantissas. The resulting floating point value may be provided to a normalizer circuitry 320 (and, in some cases a rounding circuit or bias circuit (e.g., 325)). Further, in implementations supporting multiplication of positive and negative operand values, an exclusive OR (XOR) circuit 330 may be provided, which takes the respective signs of the two operands (e.g., “1” for positive, “0” for negative) to determine a sign of the multiplier result (at 335).

The multiplier logic 305 of the heterogeneous multiplier 225 may be enhanced by additional logic, implemented in the heterogeneous multiplier 225, to allow the heterogeneous multiplier 225 to handle operands of heterogeneous data formats. In one example, the heterogeneous multiplier 225 may be provided with format management circuitry 340, operand modifier circuitry 345, and switching logic 350 to allow the circuitry of multiplier logic 305 to be used not only for floating point operands of the same data format (e.g., floating point (FP) 16), but also for operands of fixed point data format types, and operands of differing precision levels (e.g., FP16 versus FP8) of the same or different format types.

For example, format management circuitry 340 may access configuration information stored in a register 355 associated with and connected to the multiplier 225. In some cases, the configuration information written to the register may additionally identify the desired data format for the product determined using the heterogeneous multiplier 225, among potentially other, additional information. The configuration information may indicate the data format types of the operands for a current or next (or series of) multiplication operation(s) to be performed using the heterogeneous multiplier 225. In some implementations, the configuration information may be written to the register by a software manager (e.g., 360). For instance, the software manager 360 may manage or otherwise have access to a neural network definition (or other equation or algorithm for which the heterogeneous multiplier 225 is being used) and specify the desired or defined operand data formats that are to be used.

The format management circuitry 340 may accept the configuration information as an input (e.g., a digital code indicating the combination of data formats) and determine whether the logic of operand modifier 345 and/or switching logic 350 should be enabled and used to modify one or both of the operands or enable/disable one or more elements of multiplier logic 305 to allow the heterogeneous multiplier 225 to handle the operands for use in the multiplication operation. For instance, in one example, in response to detecting (in configuration information stored in register 355) that the operands are to include a floating point operand and a fixed point operand, the format manager 340 may activate operand modifier logic 345 to cause the operand modifier 345 to modify or supplement the fixed point operand such that the fixed point operand approximates a floating point operand or is otherwise compatible with the floating point multiplier circuitry of multiplier logic 305. As an example, a constant exponent value may be determined to correspond to the fixed point operand (e.g., integer (INT) operand) and may be added to the fixed point operand by the operand modifier 345 (e.g., responsive to a signal from the format manager 340). The fixed point operand may otherwise be provided as a mantissa to multiplier 310 to be multiplied by the mantissa of the floating point operand and the exponent value assigned to the fixed point operand by the operand modifier 345 may be fed to the adder to be summed with the exponent of the floating point operand. As another example, the multiplier circuitry 310 may be configured, using switching logic 350 (e.g., responsive to a signal from the format manager 340), to cause the multiplier circuitry to be effectively converted (for a given multiplication operation) from a floating point multiplier to a fixed point multiplier. For instance, where a fixed point product is to be generated from the multiplication operation, the switching logic 350 may temporarily disable one or more of the components of fixed point multiplier circuitry 310, such that a fixed point multiplication is performed, such as by disabling the exponent adder 315 and normalizer 320, among other examples. In this manner, the components of a fixed point multiplier circuit 350 may be used (and reused) to support heterogeneous operands with the support additional circuitry responsive to the specific data format used in the operands delivered to the heterogeneous multiplier 225 (e.g., from memory by a controller), among other example implementations.

As an example, in one implementation, an operand modifier 345 may convert a fixed point input (in Qm.n format) into an equivalent floating point number before being fed to the standard floating point multiplication circuitry (e.g., 310). For instance, an integer of value V (represented in specified number of bits) with QM.N format may be determined to be equivalent to a floating point number with exponent=Constant value M+Bias, and Mantissa=0.V, with the sign bit retained. The mantissa multiplication and output re-normalization path of a standard floating point multiplier may be modified (e.g., using switching logic 350) so as to treat the fixed point format input as a subnormal number since the mantissa generated for the fixed point operand is in 0.value format. The exponent adder path may be retained as is to perform the constant value (M+Bias) addition with the exponent of the floating point input. For example, a fixed point number with value 2.5 represented in Q2.6 format is 10.100000, making the equivalent floating point number FP16 for such an input S(1 bit)-E(5 bits)-Mantissa(11 bits), 1 00010 101000000, among potentially endless other examples.

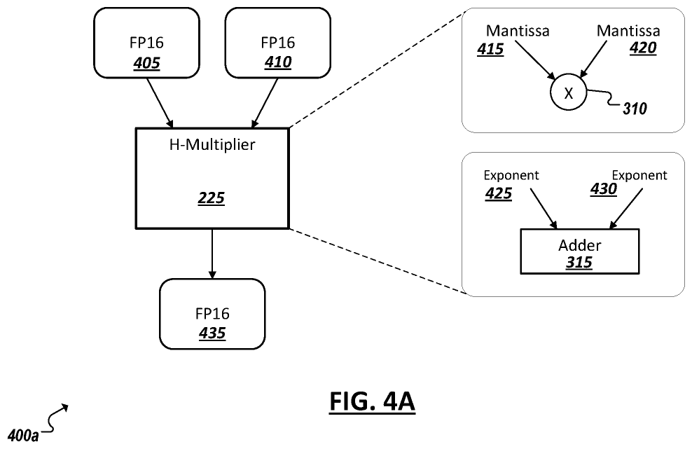

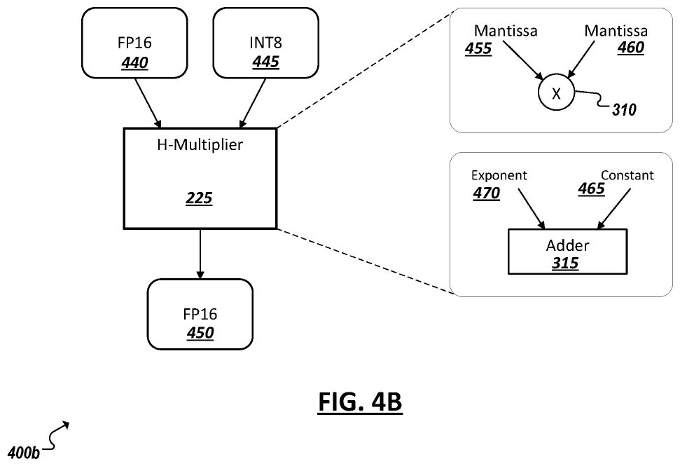

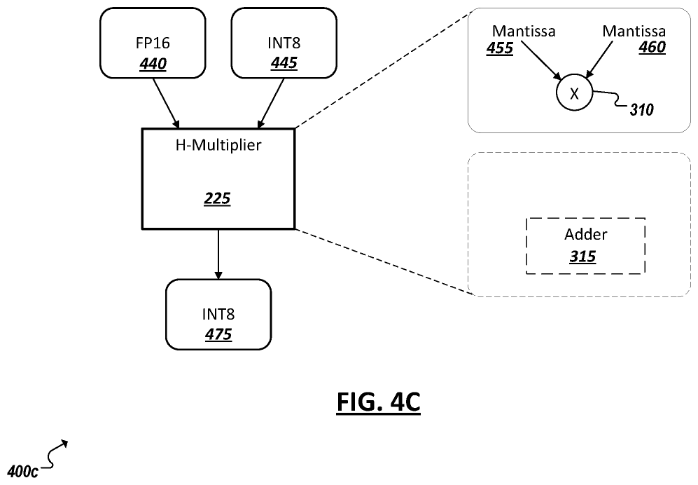

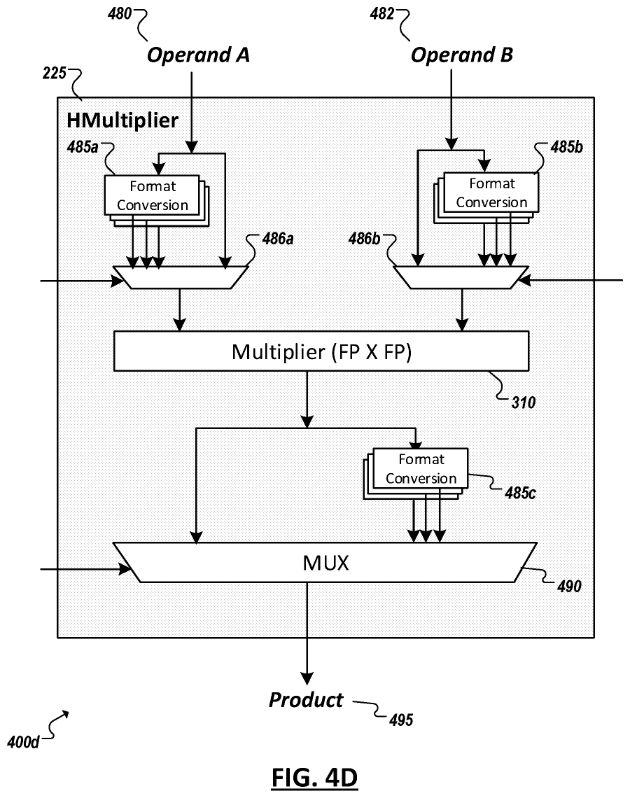

Turning to the examples of FIGS. 4A-4C, simplified block diagrams 400a-c are shown illustrating example multiplication operations involving an example heterogeneous multiplier 225. In the example of FIG. 4A, a first operand 405 and a second operand 410 are provided as inputs to the heterogeneous multiplier 225. Both of the first and second operands 405, 410 are 16-bit floating point (FP16) operands. Given that the operands 405, 410 are of the same data format (e.g., with the same numerical representation), they may be handled as in a traditional floating point multiplication, with their respective mantissas 415, 420 being multiplied by multiplier 310 and their respective exponents 425, 430 being summed by adder 315 to generate a result 435, which is also in the FP16 format.

Turning to FIG. 4B, the same heterogeneous multiplier 225 may be utilized (e.g., subsequent to the multiplication performed in the example of FIG. 4A) to multiply two other operands 440, 445, wherein one of the operands 440 is in the FP16 format and the other operand 445 is in 8-bit integer (INT8) format. In this example, not only are the operands 440, 445 of different data format types (e.g., floating point and integer), but are also of different precisions (e.g., 16-bit and 8-bit). The heterogeneous multiplier 225 may identify (e.g., from a configuration register) the respective data formats of the operands 440, 445 and may adjust the handling of the multiplication operation accordingly to complete the heterogeneous multiplication operation. In some implementations, the configuration information accessed and used by the heterogeneous multiplier 225 may also identify the data format of the product (e.g., 450) that is to be generated by the operands 440, 445. In this example, the configuration information indicates that the output of the multiplication operation to be performed by the heterogeneous multiplier 225 is to be in FP16 format. Based on the identified data formats of the operands 440, 445 and the product 450, the heterogeneous multiplier 225 may supplement (or otherwise modify) the INT8 operand 445, such that the INT8 operand may be multiplied with the FP16 operand 440 using a traditional floating point multiplier circuit. For instance, the mantissa 455 of the FP16 operand may be multiplied with a mantissa 460 defined by the integer value of operand 445. INT8 operand 445 may be modified by the heterogeneous multiplier 225 to include an associated exponent value 465 (e.g., a constant) such that operand 445 has an exponent value 465 that can be summed with the exponent value 470 of FP16 operand (using adder 315) to generate result 450.

FIG. 4C illustrates another example multiplication operation, similar to the multiplication operation illustrated in the example of FIG. 4B with the heterogeneous multiplier 225 tasked with multiplying a FP16 operand 440 with an INT8 operand 445. However, in the example of FIG. 4C, the configuration information provided to the heterogeneous multiplier 225 (e.g., by a hardware- or software-based controller or a configuration register of the heterogeneous multiplier 225, etc.) for the multiplication operation may indicate that the data format of the product 475 of the multiplication operation should be in an INT8 format. In other examples, the designated product data format may be in a format different from either of the data formats of the operands provided to the heterogeneous multiplier 225. In this example, logic of the heterogeneous multiplier 225 may realize the specified heterogeneous multiplication operation by modifying the FP16 operand to strip the exponent from the FP16 operand and may further adjust the floating point multiplier circuitry of the heterogeneous multiplier 225, for instance, by disabling the adder 315, with the mantissas of the two operands being simply provided to multiplier 310 to emulate a traditional integer multiplication operation and generate the resulting INT8 product 475.

Turning to FIG. 4D, a simplified block diagram 400d is shown illustrating another example implementation of a heterogeneous multiplier 225. In this example, format conversion logic blocks (e.g., 485a-b) may be provided to allow a given operand (e.g., 480, 482) to be converted into any one of multiple different data formats prior to being fed into a floating point multiplier 310. Multiplexer blocks (e.g., 486a-b) may also be provided to select which of the data formats (generated by conversion blocks 485a-b) should be provided to the multiplier circuitry 310. Configuration information (e.g., provided by a format manager block, as identified from a configuration register, may be fed to the multiplexer blocks (e.g., 486a-b) to direct the data formats that are to be used at the multiplier stage (e.g., 310), as well as the output stage. For instance, the product derived by the multiplier 310 may likewise be fed to a conversion stage (provided by data format converter blocks 485c), to allow the product to be converted into a desired data format (e.g., as specified in configuration data for the operation). For instance, each of the converter blocks 485c may generate a version of the product in a corresponding data format, and multiplexer 490 may likewise take, as an input, a configuration data value to select one of the outputs to return as a result 495 (e.g., based on the output configuration data format for the operation), among other example implementations.

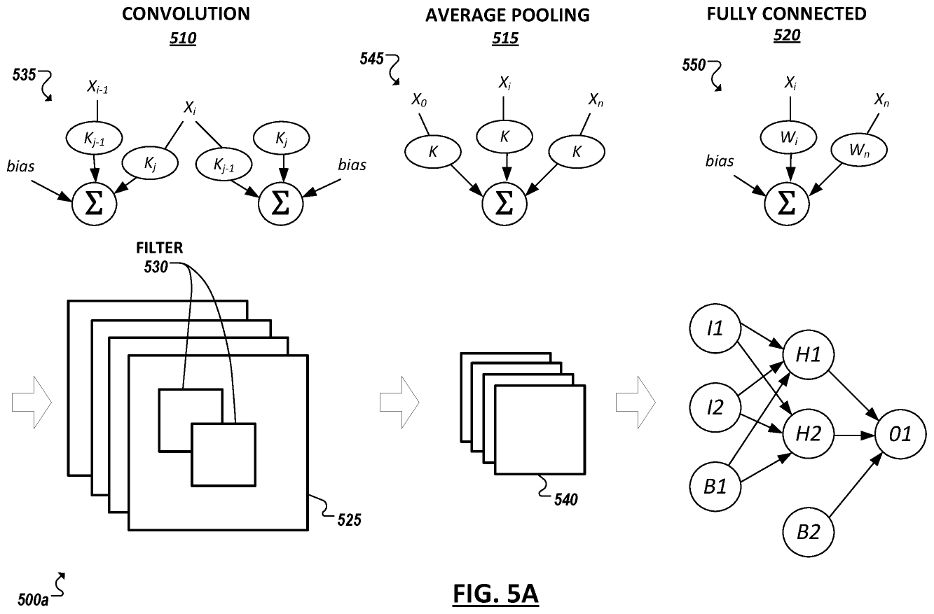

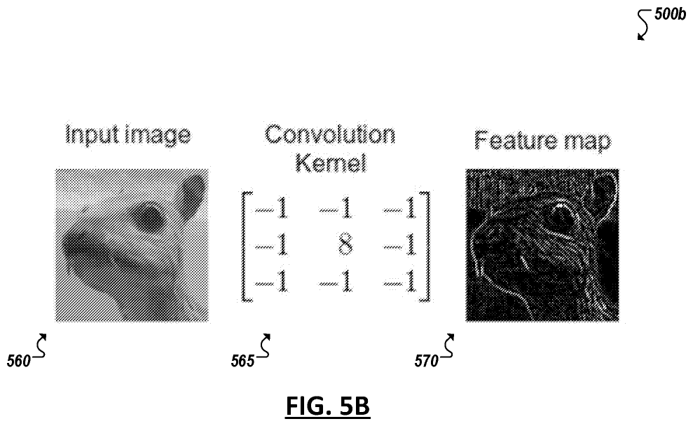

Turning to the example of FIG. 5A, as noted above, multiplication operations performed using an example implementation of a heterogeneous multiplier element may be utilized in machine learning application, such as in multiplication operations performed in applications utilizing an artificial neural network, such as a convolutional neural network (CNN). In one embodiment, such mechanisms may be implemented to improve processing of CNNs. For instance, FIG. 5A, illustrates a representation 500a of a generalized CNN that includes a convolution layer 510, an average pooling layer 515, and a fully-connected neural network 520. Operations may be specified and performed for each such layer in the CNN. For example, a sample (e.g., of an image, video stream, audio sample, etc.) may be provided as an input 525 is a sample with convolution layer 510 utilized to apply filter operations 530 to the sample data input 525. In some examples, filter operations 530 may be implemented as convolution of a kernel over the entire image as illustratively shown in element 535, in which xᵢ₋₁, xᵢ . . . represent inputs (e.g., pixel values of an image), and kⱼ₋₁, kⱼ, kⱼ₊₁ represent parameters of the kernel. Results of filter operations 530 may be summed together to provide an output from convolution layer 510 to the next pooling layer 515. Pooling layer 515 may perform subsampling to reduce the samples 525 (e.g., image samples) to a stack of reduced samples 540. Subsampling operations may be achieved through average operations or maximum value computation. Element 545 of FIG. 5A illustratively shows an average of inputs x₀, xᵢ, xₙ, etc. The output of pooling layer 515 may be fed to the fully-connected neural network 520 to perform pattern detections. Fully-connected neural network 520 may apply a set of weights 550 in its inputs and accumulate a result as the output of the fully-connected neural network layer 520, among other example implementations (including CNN implementations with more complex topographies and layers). Indeed, in practice, convolution and pooling layers may be applied to input data multiple times prior to the results being transmitted to the fully-connected layer. Thereafter, the final output value is tested to determine whether a pattern has been recognized or not.

Turning to FIG. 5B, a representation 500b is shown of an example convolution as may be employed within a CNN that takes, as inputs, images and determines one or more features from each images from which a classification may be made. As an example, an image 560 may be provided as an input and a particular convolution layer of the CNN may perform a convolution operation on the image. In this example, the input image 560 may be represented as three matrices of pixels, one matrix for each of the image's red, blue and green (RBG) color channels. Each pixel may be represented numerically, for instance, as an integer (e.g., between 0 and 255). A convolutional kernel 565 may also be defined for the particular convolution layer and may be implemented as a matrix of floating point numbers of a particular dimension. The kernel matrix values may be defined to define a particular filter to be applied to the image 560 to generate a feature map 570 of the image. For instance, pieces, or patches, of the image may be selected and element-wise multiplication of the image patch and kernel matrix may be performed. In this example, as the values of the image patch (e.g., integers of a certain precision) and values of the kernel matrix (e.g., floating point numbers of potentially a different precision), the element-wise multiplication may be performed by simply-providing these heterogeneous operands to a heterogeneous multiplier, such as discussed elsewhere herein. The product of this multiplication may then be summed (e.g., using an adder) to generate a single pixel of the feature map 570 to be generated from the convolution operation. Further, after one pixel of the feature map has been computed from the multiplication of a first patch with the kernel, the center of an image patch extractor may slide one pixel into another direction, and repeat this computation for another (neighboring and overlapping) patch of the image. The convolution computation for this particular input 560 may conclude when all pixels of the feature map 570 have been computed. In this example, given the three channels of the image sample 560, the convolution example may result in one feature map for each one of the (three) color channels, among other example implementations.

In an implementation of a CNN, each of the convolution, pooling, and fully-connected neural network layers may be implemented, for instance, through multiply-accumulate (MAC) operations. Indeed, a heterogeneous multiplier may be incorporated in a MAC unit used to perform the multiplication portions of the MAC operations. For instance, algorithms implemented on processor devices such as CPUs or GPUs may include integer (or fixed-point) multiplication and addition, or float-point fused multiply-add (FMA). These operations involve multiplication operations of inputs with parameters and then summation of the multiplication results, with the multiplication performed using, in some cases, a heterogeneous multiplier, such as discussed herein, among other examples.

Embodiments of the present disclosure may include modular calculation circuits that are reconfigurable according to the computational tasks. For instance, an example heterogeneous multiplier circuit (and, in some implementations, a heterogeneous adder circuit) may be provided, which may natively accept two operands in two different data formats and successfully complete a corresponding arithmetic operation. Indeed, the heterogeneous multiplier may be configurable to handle various combinations of operand data format depending on the desired precision and operand data formats for use in the various different layers of a CNN, as an example. Thus, embodiments of the disclosure may perform filter/convolution operations for various convolution layers and may be integrated in hardware to flexibly achieve not convolution operations, but also perform average operations for pooling layer, dot product operations for fully-connected layers, among other example features and advantages.

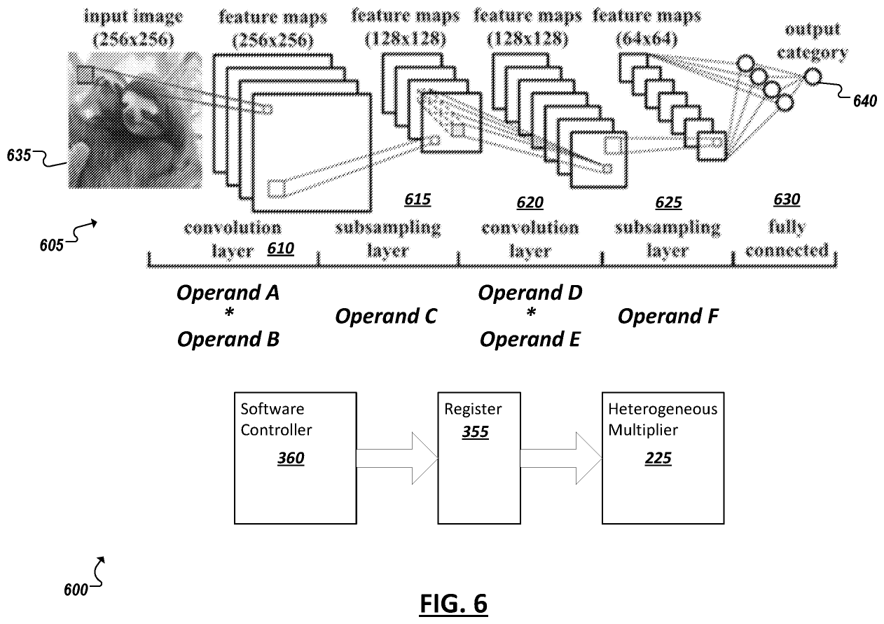

For example, turning to the simplified block diagram 600 of FIG. 6, a representation of an example CNN 605 is illustrated, including two convolution layers 610, 615, each followed by a respective subsampling, or pooling, layer 620, 625, and concluded with a fully connected layer 630, to perform a classification (e.g., 640) of various samples (e.g., images 635) that are input to the CNN 605. Corresponding operations may be defined to be performed in each of the CNN layers 610, 615, 620, 625, 630, including layers other than convolution layers, such as in fully connected layers (e.g., 630). Further, the CNN may be defined to specify the data formats to be used in each of the calculations across the layers of the CNN (e.g., 605), including whether floating point or fixed point data numerical representations are to be used and/or the precision (e.g., 8-bit, 16-bit, 32-bit, etc.) of the data format.

In some implementations, a CNN (e.g., 605) may be designed and defined based on optimization modeling performed to determine which operand formats result in the greatest (or sufficient target) accuracy for the CNN. As an example, Operand A in convolution layer 610 may be (advantageously) in a different data format (e.g., FP16) than Operand B (e.g., INT8) that is to be provided as the second operand in a convolution operation performed in connection with the convolution layer 610. Additionally, operands (e.g., Operand D and Operand E) in another convolution layer (e.g., 620) may adopt data formats different than the data formats utilized in the preceding convolution operation of convolution layer 610. Indeed, in some cases, the data formats of two operands used in a convolution operation may be natively in the same data format. Further, the result of one layer's operation (e.g., a convolution operation of convolution layer 610) may serve as an operand (e.g., Operand C) in the following layer of the CNN (e.g., subsampling layer 615). As there may also be design considerations that dictate or suggest that the operands of this next layer (e.g., 615) be of a particular data format, the data formats and operation used in the preceding operation (e.g., the convolution operation of either convolution layer 610 or 620) may be appropriately configured such that the result of the operation (e.g., Operand C or Operand F) result in a particular data format to accommodate the next layer, among other example considerations.

As further illustrated in the example FIG. 6, in connection with the definition of a particular neural network (e.g., CNN 605) and the specific data formats to be used in each layer's respective operations, configuration information may be generated to correspond with this definition, which may be provided to a heterogeneous multiplier (or adder) to configure the multiplier's use in the corresponding operation (such as discussed in the example of FIG. 3). For instance, a software manager may be tasked with accessing data specifying a definition of a particular CNN and causing the hardware used to perform operations defined within the CNN to perform these operations in an efficient manner and in accordance with the CNN definition. Accordingly, in one example, a software manager 360 may program a register 355 associated with a particular heterogeneous multiplier 225 with configuration information that is to be consumed by the heterogeneous multiplier 225 to configure its handling of an upcoming operation for a particular layer in a defined CNN 605. For instance, the software controller 360 may write configuration information to register 355 to configure the operation of the heterogeneous multiplier 225 for a particular multiplication operation (or series of related multiplication operations) for a particular layer (e.g., a multiplication within a convolution operation performed in convolution layer 610) of the CNN 605 managed using the software controller 360.

As an example, the configuration information specified by the software controller 360 may indicate that a first operand (e.g., Operand A) of the particular multiplication operation is to be in a first data format (e.g., FP8), a second operand is to be in a second data format (e.g., FP16), and the output of the multiplication is to be in the second data format (e.g., FP16). For a later multiplication operation to be performed by the heterogeneous multiplier 225 in connection with another one of the CNN's layers (e.g., convolution layer 620), the software controller may overwrite the configuration information provided for the earlier multiplication operation with configuration information corresponding to the definition for layer 620. For instance, for the convolution operation of convolution layer 620, the software control 360 may access the CNN definition and specify, in register 355, that the multiplication operation performed in the convolution by the heterogeneous multiplier 225 is to be adapted to perform a multiplication operation where the combination of data formats of the operands (e.g., Operand D and Operand E) are different from the combination of data formats (e.g., FP8 and FP16) utilized in the multiplication operation of convolution layer 610, among other examples. In this manner, the configuration register 355 of a heterogeneous multiplier 225 may be updated to reflect the combination of data formats of the operands (and potentially also the product) that are to be used in an upcoming or present multiplication operation. The heterogeneous multiplier 225 may accept the configuration information as an input to be used to either modify one or more of the operands and/or enable/disable multiplication logic of the heterogeneous multiplier 225 to successfully perform the multiplication and realize a product in a desired data format, among other examples.

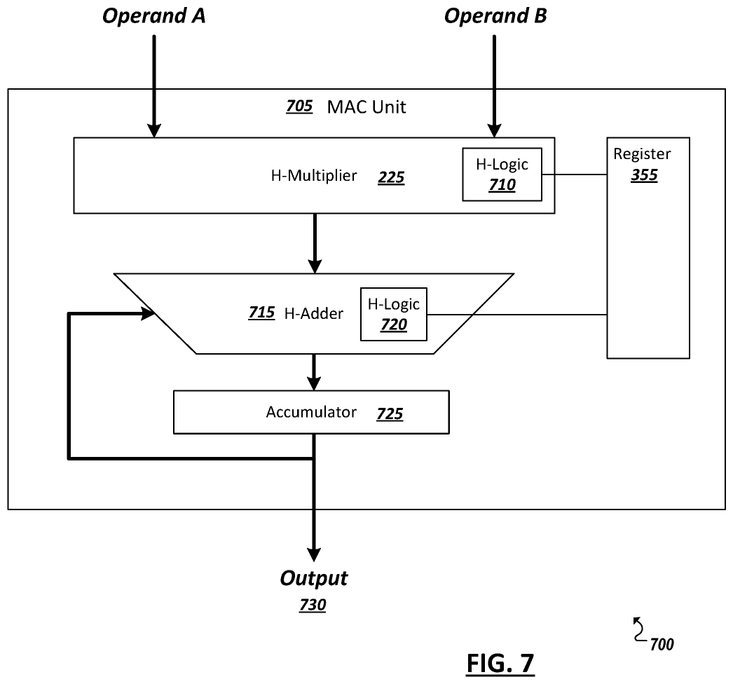

As discussed above, an example heterogeneous multiplier may be implemented in a MAC unit, in some implementations. For instance, FIG. 7 is a simplified block diagram 700 illustrating an example implementation of a MAC unit 705. The MAC unit 705 may include an implementation of heterogeneous multiplier circuitry 225 such as discussed herein. As noted above, the heterogeneous multiplier 225 may be implemented as an enhance floating point multiplier with additional hardware logic 710 to modify one or both operands or switch on or off various logic of the multiplier to allow the heterogeneous multiplier 225 to perform a desired multiplication operation with operands of either homogeneous or heterogeneous data formats. The MAC unit 705 may additionally include adder circuitry 715, which may accept the product-output of the heterogeneous multiplier 225 in a register stage of the MAC 705. An accumulator 725 may accept the output of the adder 715 and provide its result as feedback to the adder 715.

In some implementations, the heterogeneous multiplier 225 may be configured to produce an output in a particular data format such that the end result (e.g., 730) of the convolution operation, as performed by the MAC unit 705, is in a specific data format. In some implementations, in addition to (or an alternative to) the inclusion of a heterogeneous multiplier 225 in the MAC unit 705, the adder circuitry 715 may also be implemented with additional logic (e.g., 720) to enable adder circuitry 715 to function as a heterogeneous adder that is able to accept a variety of different data formats, including operands with heterogeneous data formats. For instance, in some cases, a larger number of accumulations may be provided in the MAC unit 705. In instances where the inputs of the multiplier are of lower precision, the enhanced MAC unit 705 may enable the adder circuitry 715 to maintain higher precision so that the truncation/rounding would happen only at the end of all accumulation, which could lead to a better accuracy. For instance, two inputs of the multiplier may be in fixed point format. The product may be fed it into a floating point adder circuitry supplemented with logic 720, allowing the intermediate accumulated value to be stored in a higher precision format, among other examples.

As in some of the examples discussed above, a configuration register 355 may be provided through which a controller may configure a heterogeneous multiplier 325 to handle a specific combination of operand data formats. In implementations where an example MAC unit 705 includes both a heterogeneous multiplier 325 and a heterogeneous adder (e.g., 715), a controller may provide configuration data through one or more configuration registers (e.g., 355) to configure both the heterogeneous multiplier 325 and the heterogeneous adder 715. In some implementations, configuration information provided through a single configuration register associated with (or included in) the MAC unit may be used to configure both the heterogeneous multiplier 325 and the heterogeneous adder 715. In other examples, separate configuration registers may be provided for each of the heterogeneous multiplier 325 and the heterogeneous adder 715, in which separate corresponding configuration information may be provided to the heterogeneous multiplier 325 and adder 715, among other example implementations.

It should be appreciated that the example systems and implementations illustrated and discussed above are presented for illustration purposes only and do not represent limiting examples of the broader principles and features proposed in this disclosure. Indeed, a variety of alternative implementations may be designed and realized that include or are built upon these principles and features, among other example considerations.

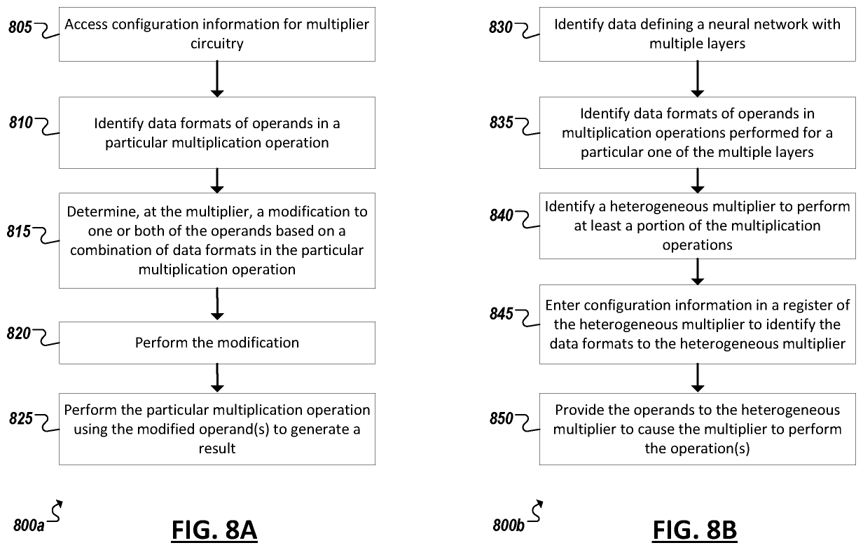

FIGS. 8A-8B are simplified flowchart 800a-b illustrating example techniques utilizing example heterogeneous multiplier circuitry. For instance, in FIG. 8A, heterogeneous multiplier circuitry (such as discussed in the example implementations above) accesses 805 configuration information corresponding to a particular multiplication operation (e.g., by pulling the configuration information from a configuration register, receiving an instruction from controller, etc.). The heterogeneous multiplier circuitry may identify 810 from the configuration information that a particular multiplication operation (e.g., the next multiplication operation to be performed by the heterogeneous multiplier circuitry, a coming series of multiplication operations, etc.) will include operands of particular data formats, including different, or heterogeneous, data formats, such as data formats of different types (e.g., floating point, integer (or other fixed point number of a corresponding Q format), etc.) and/or data formats of different precisions (e.g., 4-bit, 8-bit, 16-bit, etc.), among other examples. The heterogeneous multiplier circuitry, in some instances, may determine 815, from the configuration information (and based on the combination of data formats specified for the operands in the configuration data), that a modification is to be made to at least one of the operands at the heterogeneous multiplier circuitry to prepare the respective operand for multiplication with the other operand to generate a product in a particular data format. In some cases, the configuration information may also specify the desired data format of the multiplication operation's product and determining 815 the modification may be further based on the specified data format of the product output of the heterogeneous multiplier circuitry. The heterogeneous multiplier circuitry may perform 820 the modification(s) on the one or more operands based on this determination 815 to generate modified versions of the one or more operands. The particular multiplication operation may then be performed 825 by the heterogeneous multiplier circuitry to generate a result, which may be passed to one or other compute components in a computing system, among other example implementations. In some implementations, multiple MAC units (e.g., 220a-c) may be utilized to perform operations for a particular application or sub-part of the application and the group of MAC units (and their respective heterogeneous multipliers and/or adders) may be jointly configured with the same configuration (e.g., such that the heterogeneous multipliers and adders of the MAC units operate in the same manner for these operations).

Turning to FIG. 8B, a controller may be implemented in hardware and/or software to configure and reconfigure heterogeneous multiplier circuitry for the various multiplication operations it may be called on to perform with potentially operands of multiple different combinations of data formats. For instance, the controller may identify 830 data defining a neural network, including the definition of the multiple layers of the neural networks (e.g., the layers of a particular convolutional neural network (CNN)). The controller may identify 835, from the definition, that specific data formats have been defined for the operands in multiplication (and potentially also addition) operations to be performed by hardware used for the neural network. The hardware may include one or more instances of heterogeneous multiplier circuitry, such as discussed above. The controller may identify that a particular heterogeneous multiplier is to perform at least some of the multiplication operations associated with the particular network layer and may work to configure the heterogeneous multiplier to prepare the particular heterogeneous multiplier to perform the multiplication operation. Specifically, in some implementations, the controller may enter configuration information in a register associated with the particular heterogeneous multiplier to identify the data formats of the operands that will be provided to the particular heterogeneous multiplier in the multiplication operation. The heterogeneous multiplier may read or pull the configuration information from the register to access the configuration information to guide its handling of the operands. The controller may provide 850 the operands to the particular heterogeneous multiplier circuitry and cause it to perform the multiplication operation(s). The controller may likewise direct other instances of heterogeneous multiplier circuitry, as well as other compute components, to orchestrate the performance of various operations (e.g., multiplication, addition, convolution, accumulation, etc.) by the compute components to, in some cases, optimize the work to be performed in connection with the neural network, among other example implementations and features.

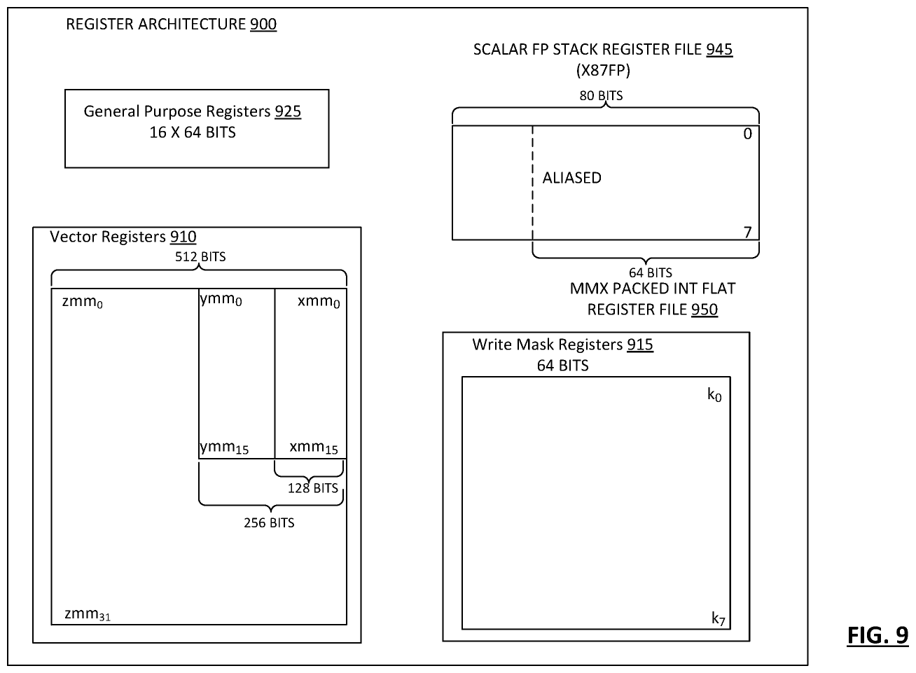

It should be appreciated that the examples illustrated and discussed above are provided for purposes of illustrating broader principles and features, and are provided as illustrative examples only. Indeed, other alternative or additional features and implementations may be provided that do not deviate from the broader concepts illustrated herein. As examples, FIGS. 9-17 detail exemplary architectures and systems to implement or use heterogeneous multiplier circuitry and other components discussed above. In some embodiments, one or more hardware components and/or instructions described above are emulated as detailed below, or implemented as software modules. Indeed, embodiments of the instruction(s) detailed above are embodied may be embodied in a “generic vector friendly instruction format” which is detailed below. In other embodiments, such a format is not utilized and another instruction format is used, however, the description below of the writemask registers, various data transformations (swizzle, broadcast, etc.), addressing, etc. is generally applicable to the description of the embodiments of the instruction(s) above. Additionally, exemplary systems, architectures, and pipelines are detailed below. Embodiments of the instruction(s) above may be executed on such systems, architectures, and pipelines, but are not limited to those detailed.

An instruction set may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down though the definition of instruction templates (or subformats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an exemplary ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands. A set of SIMD extensions referred to as the Advanced Vector Extensions (AVX) (AVX1 and AVX2) and using the Vector Extensions (VEX) coding scheme has been released and/or published (e.g., see Intel® 64 and IA-32 Architectures Software Developer's Manual, September 2014; and see Intel® Advanced Vector Extensions Programming Reference, October 2014).

FIG. 9 is a block diagram of a register architecture 900 according to one embodiment of the invention. In the embodiment illustrated, there are 32 vector registers 910 that are 512 bits wide; these registers are referenced as zmm0 through zmm31. The lower order 256 bits of the lower 16 zmm registers are overlaid on registers ymm0-16. The lower order 128 bits of the lower 16 zmm registers (the lower order 128 bits of the ymm registers) are overlaid on registers xmm0-15.

In other words, the vector length field selects between a maximum length and one or more other shorter lengths, where each such shorter length is half the length of the preceding length; and instructions templates without the vector length field operate on the maximum vector length. Further, in one embodiment, the class B instruction templates of the specific vector friendly instruction format operate on packed or scalar single/double-precision floating point data and packed or scalar integer data. Scalar operations are operations performed on the lowest order data element position in an zmm/ymm/xmm register; the higher order data element positions are either left the same as they were prior to the instruction or zeroed depending on the embodiment.

Write mask registers 915—in the embodiment illustrated, there are 8 write mask registers (k0 through k7), each 64 bits in size. In an alternate embodiment, the write mask registers 915 are 16 bits in size. As previously described, in one embodiment of the invention, the vector mask register k0 cannot be used as a write mask; when the encoding that would normally indicate k0 is used for a write mask, it selects a hardwired write mask of 0xFFFF, effectively disabling write masking for that instruction.

General-purpose registers 925—in the embodiment illustrated, there are sixteen 64-bit general-purpose registers that are used along with the existing x86 addressing modes to address memory operands. These registers are referenced by the names RAX, RBX, RCX, RDX, RBP, RSI, RDI, RSP, and R8 through R15.

Scalar floating point stack register file (x87 stack) 945, on which is aliased the MMX packed integer flat register file 950—in the embodiment illustrated, the x87 stack is an eight-element stack used to perform scalar floating-point operations on 32/64/80-bit floating point data using the x87 instruction set extension; while the MMX registers are used to perform operations on 64-bit packed integer data, as well as to hold operands for some operations performed between the MMX and XMM registers.

Alternative embodiments of the invention may use wider or narrower registers. Additionally, alternative embodiments of the invention may use more, less, or different register files and registers.

Processor cores may be implemented in different ways, for different purposes, and in different processors. For instance, implementations of such cores may include: 1) a general purpose in-order core intended for general-purpose computing; 2) a high performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die the described CPU (sometimes referred to as the application core(s) or application processor(s)), the above described coprocessor, and additional functionality. Exemplary core architectures are described next, followed by descriptions of exemplary processors and computer architectures.

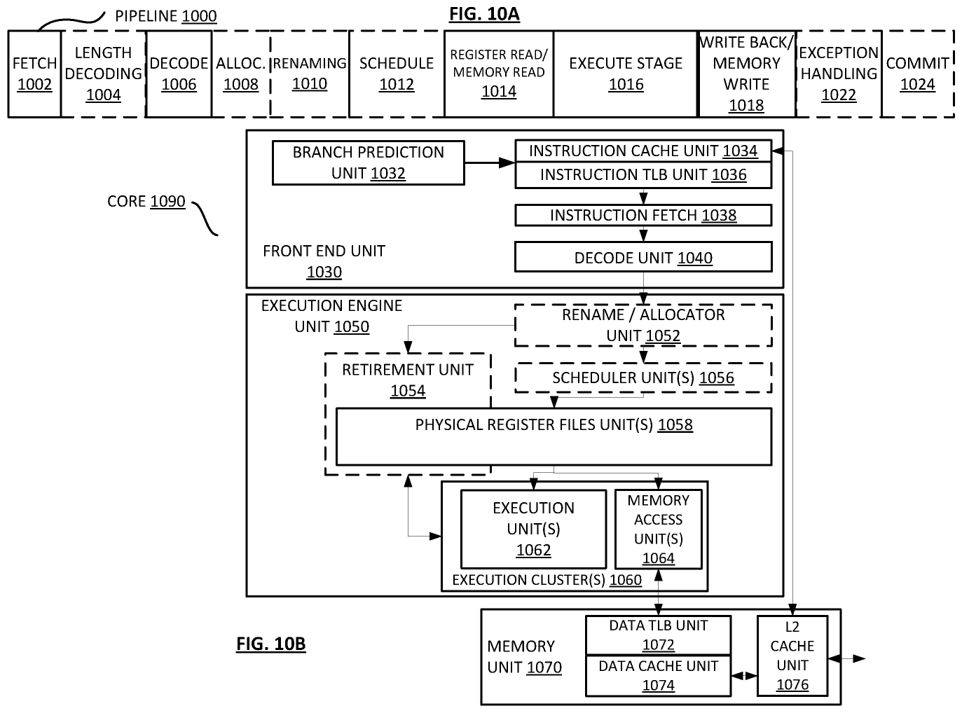

FIG. 10A is a block diagram illustrating both an exemplary in-order pipeline and an exemplary register renaming, out-of-order issue/execution pipeline according to embodiments of the invention. FIG. 10B is a block diagram illustrating both an exemplary embodiment of an in-order architecture core and an exemplary register renaming, out-of-order issue/execution architecture core to be included in a processor according to embodiments of the invention. The solid lined boxes in FIGS. 10A-10B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 10A, a processor pipeline 1000 includes a fetch stage 1002, a length decode stage 1004, a decode stage 1006, an allocation stage 1008, a renaming stage 1010, a scheduling (also known as a dispatch or issue) stage 1012, a register read/memory read stage 1014, an execute stage 1016, a write back/memory write stage 1018, an exception handling stage 1022, and a commit stage 1024.

FIG. 10B shows processor core 1090 including a front end unit 1030 coupled to an execution engine unit 1050, and both are coupled to a memory unit 1070. The core 1090 may be a reduced instruction set computing (RISC) core, a complex instruction set computing (CISC) core, a very long instruction word (VLIW) core, or a hybrid or alternative core type. As yet another option, the core 1090 may be a special-purpose core, such as, for example, a network or communication core, compression engine, coprocessor core, general purpose computing graphics processing unit (GPGPU) core, graphics core, or the like.

The front end unit 1030 includes a branch prediction unit 1032 coupled to an instruction cache unit 1034, which is coupled to an instruction translation lookaside buffer (TLB) 1036, which is coupled to an instruction fetch unit 1038, which is coupled to a decode unit 1040. The decode unit 1040 (or decoder) may decode instructions, and generate as an output one or more micro-operations, micro-code entry points, microinstructions, other instructions, or other control signals, which are decoded from, or which otherwise reflect, or are derived from, the original instructions. The decode unit 1040 may be implemented using various different mechanisms. Examples of suitable mechanisms include, but are not limited to, look-up tables, hardware implementations, programmable logic arrays (PLAs), microcode read only memories (ROMs), etc. In one embodiment, the core 1090 includes a microcode ROM or other medium that stores microcode for certain macroinstructions (e.g., in decode unit 1040 or otherwise within the front end unit 1030). The decode unit 1040 is coupled to a rename/allocator unit 1052 in the execution engine unit 1050.

The execution engine unit 1050 includes the rename/allocator unit 1052 coupled to a retirement unit 1054 and a set of one or more scheduler unit(s) 1056. The scheduler unit(s) 1056 represents any number of different schedulers, including reservations stations, central instruction window, etc. The scheduler unit(s) 1056 is coupled to the physical register file(s) unit(s) 1058. Each of the physical register file(s) units 1058 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) unit 1058 comprises a vector registers unit, a write mask registers unit, and a scalar registers unit. These register units may provide architectural vector registers, vector mask registers, and general purpose registers. The physical register file(s) unit(s) 1058 is overlapped by the retirement unit 1054 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 1054 and the physical register file(s) unit(s) 1058 are coupled to the execution cluster(s) 1060. The execution cluster(s) 1060 includes a set of one or more execution units 1062 and a set of one or more memory access units 1064. The execution units 1062 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 1056, physical register file(s) unit(s) 1058, and execution cluster(s) 1060 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 1064). It should also be understood that where separate pipelines are used, one or more of these pipelines may be out-of-order issue/execution and the rest in-order.

The set of memory access units 1064 is coupled to the memory unit 1070, which includes a data TLB unit 1072 coupled to a data cache unit 1074 coupled to a level 2 (L2) cache unit 1076. In one exemplary embodiment, the memory access units 1064 may include a load unit, a store address unit, and a store data unit, each of which is coupled to the data TLB unit 1072 in the memory unit 1070. The instruction cache unit 1034 is further coupled to a level 2 (L2) cache unit 1076 in the memory unit 1070. The L2 cache unit 1076 is coupled to one or more other levels of cache and eventually to a main memory.

By way of example, the exemplary register renaming, out-of-order issue/execution core architecture may implement the pipeline 1000 as follows: 1) the instruction fetch 1038 performs the fetch and length decoding stages 1002 and 1004; 2) the decode unit 1040 performs the decode stage 1006; 3) the rename/allocator unit 1052 performs the allocation stage 1008 and renaming stage 1010; 4) the scheduler unit(s) 1056 performs the schedule stage 1012; 5) the physical register file(s) unit(s) 1058 and the memory unit 1070 perform the register read/memory read stage 1014; the execution cluster 1060 perform the execute stage 1016; 6) the memory unit 1070 and the physical register file(s) unit(s) 1058 perform the write back/memory write stage 1018; 7) various units may be involved in the exception handling stage 1022; and 8) the retirement unit 1054 and the physical register file(s) unit(s) 1058 perform the commit stage 1024.

The core 1090 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.), including the instruction(s) described herein. In one embodiment, the core 1090 includes logic to support a packed data instruction set extension (e.g., AVX1, AVX2), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes separate instruction and data cache units 1034/1074 and a shared L2 cache unit 1076, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

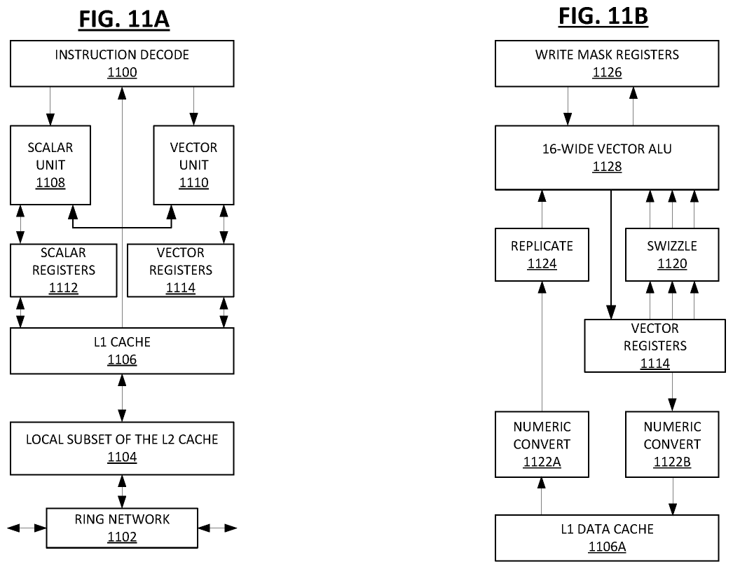

FIGS. 11A-11B illustrate a block diagram of a more specific exemplary in-order core architecture, which core would be one of several logic blocks (including other cores of the same type and/or different types) in a chip. The logic blocks communicate through a high-bandwidth interconnect network (e.g., a ring network) with some fixed function logic, memory I/O interfaces, and other necessary I/O logic, depending on the application.

FIG. 11A is a block diagram of a single processor core, along with its connection to the on-die interconnect network 1102 and with its local subset of the Level 2 (L2) cache 1104, according to embodiments of the invention. In one embodiment, an instruction decoder 1100 supports the x86 instruction set with a packed data instruction set extension. An L1 cache 1106 allows low-latency accesses to cache memory into the scalar and vector units. While in one embodiment (to simplify the design), a scalar unit 1108 and a vector unit 1110 use separate register sets (respectively, scalar registers 1112 and vector registers 1114) and data transferred between them is written to memory and then read back in from a level 1 (L1) cache 1106, alternative embodiments of the invention may use a different approach (e.g., use a single register set or include a communication path that allow data to be transferred between the two register files without being written and read back).

The local subset of the L2 cache 1104 is part of a global L2 cache that is divided into separate local subsets, one per processor core. Each processor core has a direct access path to its own local subset of the L2 cache 1104. Data read by a processor core is stored in its L2 cache subset 1104 and can be accessed quickly, in parallel with other processor cores accessing their own local L2 cache subsets. Data written by a processor core is stored in its own L2 cache subset 1104 and is flushed from other subsets, if necessary. The ring network ensures coherency for shared data. The ring network is bi-directional to allow agents such as processor cores, L2 caches and other logic blocks to communicate with each other within the chip. Each ring data-path is 1012-bits wide per direction.

FIG. 11B is an expanded view of part of the processor core in FIG. 11A according to embodiments of the invention. FIG. 11B includes an L1 data cache 1106A part of the L1 cache 1104, as well as more detail regarding the vector unit 1110 and the vector registers 1114. Specifically, the vector unit 1110 is a 16-wide vector processing unit (VPU) (see the 16-wide ALU 1128), which executes one or more of integer, single-precision float, and double-precision float instructions. The VPU supports swizzling the register inputs with swizzle unit 1120, numeric conversion with numeric convert units 1122A-B, and replication with replication unit 1124 on the memory input. Write mask registers 1126 allow predicating resulting vector writes.

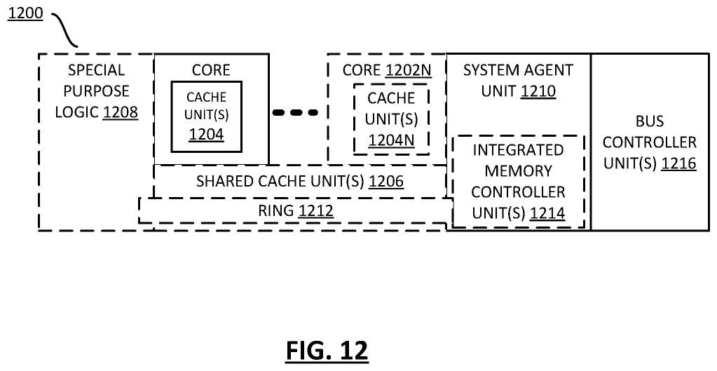

FIG. 12 is a block diagram of a processor 1200 that may have more than one core, may have an integrated memory controller, and may have integrated graphics according to embodiments of the invention. The solid lined boxes in FIG. 12 illustrate a processor 1200 with a single core 1202A, a system agent 1210, a set of one or more bus controller units 1216, while the optional addition of the dashed lined boxes illustrates an alternative processor 1200 with multiple cores 1202A-N, a set of one or more integrated memory controller unit(s) 1214 in the system agent unit 1210, and special purpose logic 1208.

Thus, different implementations of the processor 1200 may include: 1) a CPU with the special purpose logic 1208 being integrated graphics and/or scientific (throughput) logic (which may include one or more cores), and the cores 1202A-N being one or more general purpose cores (e.g., general purpose in-order cores, general purpose out-of-order cores, a combination of the two); 2) a coprocessor with the cores 1202A-N being a large number of special purpose cores intended primarily for graphics and/or scientific (throughput); and 3) a coprocessor with the cores 1202A-N being a large number of general purpose in-order cores. Thus, the processor 1200 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 1200 may be a part of and/or may be implemented on one or more substrates using any of a number of process technologies, such as, for example, BiCMOS, CMOS, or NMOS.

The memory hierarchy includes one or more levels of cache within the cores, a set or one or more shared cache units 1206, and external memory (not shown) coupled to the set of integrated memory controller units 1214. The set of shared cache units 1206 may include one or more mid-level caches, such as level 2 (L2), level 3 (L3), level 4 (L4), or other levels of cache, a last level cache (LLC), and/or combinations thereof. While in one embodiment a ring based interconnect unit 1212 interconnects the integrated graphics logic 1208, the set of shared cache units 1206, and the system agent unit 1210/integrated memory controller unit(s) 1214, alternative embodiments may use any number of well-known techniques for interconnecting such units. In one embodiment, coherency is maintained between one or more cache units 1206 and cores 1202A-N.

In some embodiments, one or more of the cores 1202A-N are capable of multi-threading. The system agent 1210 includes those components coordinating and operating cores 1202A-N. The system agent unit 1210 may include for example a power control unit (PCU) and a display unit. The PCU may be or include logic and components needed for regulating the power state of the cores 1202A-N and the integrated graphics logic 1208. The display unit is for driving one or more externally connected displays.

The cores 1202A-N may be homogenous or heterogeneous in terms of architecture instruction set; that is, two or more of the cores 1202A-N may be capable of execution the same instruction set, while others may be capable of executing only a subset of that instruction set or a different instruction set.

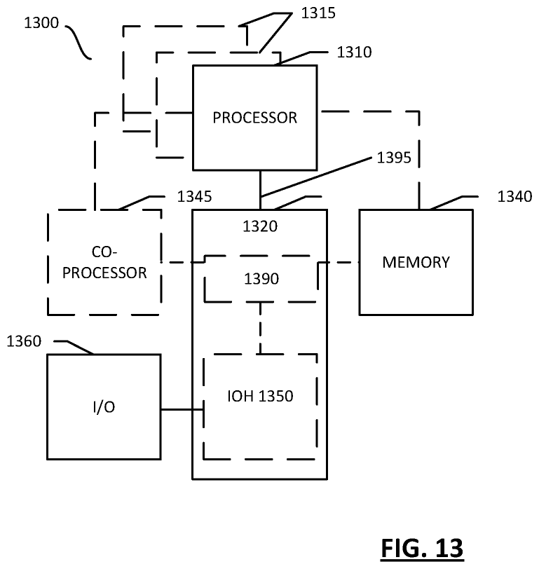

FIGS. 13-16 are block diagrams of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Referring now to FIG. 13, shown is a block diagram of a system 1300 in accordance with one embodiment of the present invention. The system 1300 may include one or more processors 1310, 1315, which are coupled to a controller hub 1320. In one embodiment the controller hub 1320 includes a graphics memory controller hub (GMCH) 1390 and an Input/Output Hub (IOH) 1350 (which may be on separate chips); the GMCH 1390 includes memory and graphics controllers to which are coupled memory 1340 and a coprocessor 1345; the IOH 1350 is couples input/output (I/O) devices 1360 to the GMCH 1390. Alternatively, one or both of the memory and graphics controllers are integrated within the processor (as described herein), the memory 1340 and the coprocessor 1345 are coupled directly to the processor 1310, and the controller hub 1320 in a single chip with the IOH 1350.

The optional nature of additional processors 1315 is denoted in FIG. 13 with broken lines. Each processor 1310, 1315 may include one or more of the processing cores described herein and may be some version of the processor 1200.

The memory 1340 may be, for example, dynamic random access memory (DRAM), phase change memory (PCM), or a combination of the two. For at least one embodiment, the controller hub 1320 communicates with the processor(s) 1310, 1315 via a multi-drop bus, such as a frontside bus (FSB), point-to-point interface such as QuickPath Interconnect (QPI), UltraPath Interconnect (UPI), or similar connection 1395.

In one embodiment, the coprocessor 1345 is a special-purpose processor, such as, for example, a high-throughput MIC processor, a network or communication processor, compression engine, graphics processor, GPGPU, embedded processor, or the like. In one embodiment, controller hub 1320 may include an integrated graphics accelerator.

There can be a variety of differences between the physical resources 1310, 1315 in terms of a spectrum of metrics of merit including architectural, microarchitectural, thermal, power consumption characteristics, and the like.

In one embodiment, the processor 1310 executes instructions that control data processing operations of a general type. Embedded within the instructions may be coprocessor instructions. The processor 1310 recognizes these coprocessor instructions as being of a type that should be executed by the attached coprocessor 1345. Accordingly, the processor 1310 issues these coprocessor instructions (or control signals representing coprocessor instructions) on a coprocessor bus or other interconnect, to coprocessor 1345. Coprocessor(s) 1345 accept and execute the received coprocessor instructions.

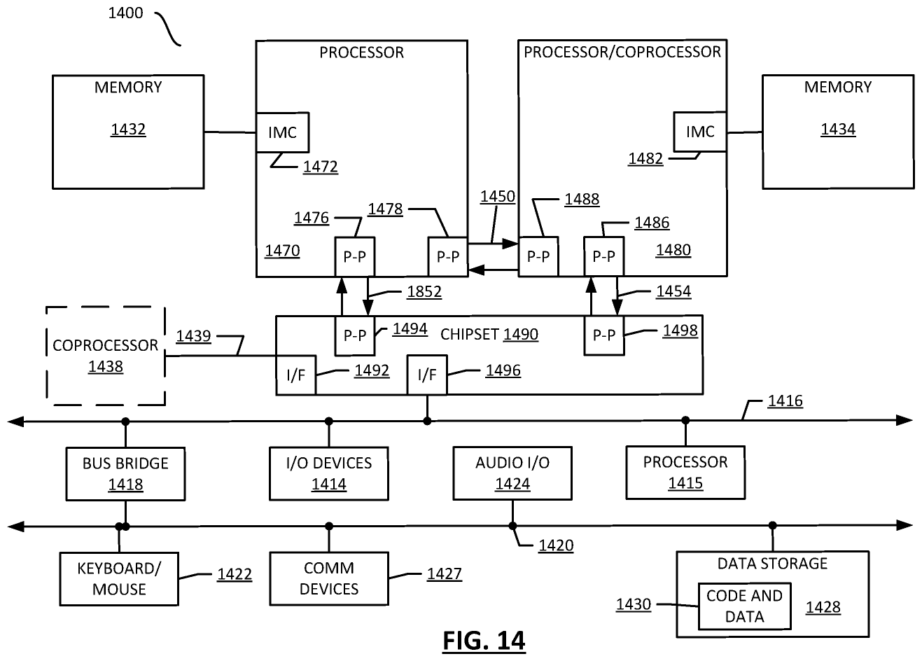

Referring now to FIG. 14, shown is a block diagram of a first more specific exemplary system 1400 in accordance with an embodiment of the present invention. As shown in FIG. 14, multiprocessor system 1400 is a point-to-point interconnect system, and includes a first processor 1470 and a second processor 1480 coupled via a point-to-point interconnect 1450. Each of processors 1470 and 1480 may be some version of the processor 1200. In one embodiment of the invention, processors 1470 and 1480 are respectively processors 1310 and 1315, while coprocessor 1438 is coprocessor 1345. In another embodiment, processors 1470 and 1480 are respectively processor 1310 coprocessor 1345.

Processors 1470 and 1480 are shown including integrated memory controller (IMC) units 1472 and 1482, respectively. Processor 1470 also includes as part of its bus controller units point-to-point (P-P) interfaces 1476 and 1478; similarly, second processor 1480 includes P-P interfaces 1486 and 1488. Processors 1470, 1480 may exchange information via a point-to-point (P-P) interface 1450 using P-P interface circuits 1478, 1488. As shown in FIG. 14, IMCs 1472 and 1482 couple the processors to respective memories, namely a memory 1432 and a memory 1434, which may be portions of main memory locally attached to the respective processors.

Processors 1470, 1480 may each exchange information with a chipset 1490 via individual P-P interfaces 1452, 1454 using point to point interface circuits 1476, 1494, 1486, 1498. Chipset 1490 may optionally exchange information with the coprocessor 1438 via a high-performance interface 1439. In one embodiment, the coprocessor 1438 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 1490 may be coupled to a first bus 1416 via an interface 1496. In one embodiment, first bus 1416 may be a Peripheral Component Interconnect (PCI) bus, or a bus such as a PCI Express bus or another third generation I/O interconnect bus, although the scope of the present invention is not so limited.

As shown in FIG. 14, various I/O devices 1414 may be coupled to first bus 1416, along with a bus bridge 1418 which couples first bus 1416 to a second bus 1420. In one embodiment, one or more additional processor(s) 1415, such as coprocessors, high-throughput MIC processors, GPGPU's, accelerators (such as, e.g., graphics accelerators or digital signal processing (DSP) units), field programmable gate arrays, or any other processor, are coupled to first bus 1416. In one embodiment, second bus 1420 may be a low pin count (LPC) bus. Various devices may be coupled to a second bus 1420 including, for example, a keyboard and/or mouse 1422, communication devices 1427 and a storage unit 1428 such as a disk drive or other mass storage device which may include instructions/code and data 1430, in one embodiment. Further, an audio I/O 1424 may be coupled to the second bus 1420. Note that other architectures are possible. For example, instead of the point-to-point architecture of FIG. 14, a system may implement a multi-drop bus or other such architecture.

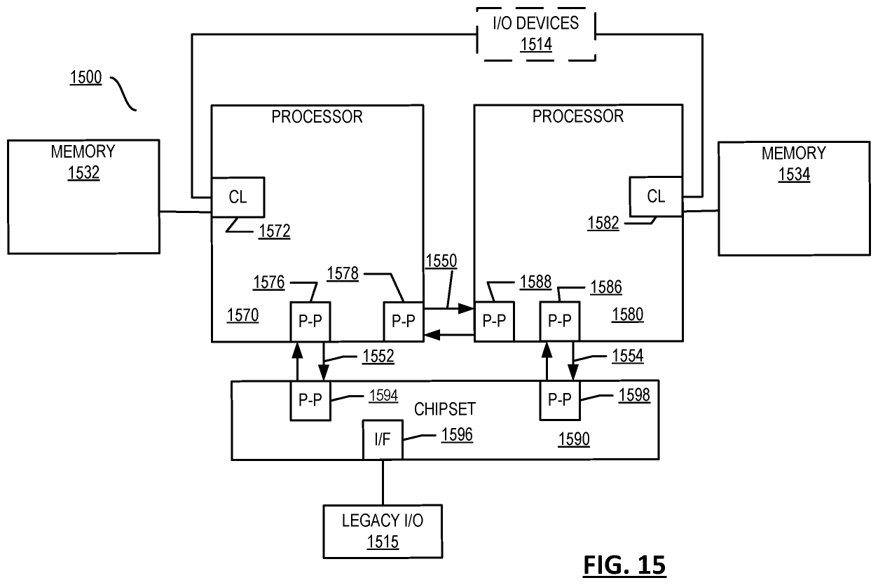

Referring now to FIG. 15, shown is a block diagram of a second more specific exemplary system 1500 in accordance with an embodiment of the present invention. For instance, FIG. 15 illustrates that the processors 1570, 1580 may include integrated memory and I/O control logic (“CL”) 1572 and 1582, respectively. Thus, the CL 1572, 1582 include integrated memory controller units and include I/O control logic. FIG. 15 illustrates that not only are the memories 1532, 1534 coupled to the CL 1572, 1582, but also that I/O devices 1514 are also coupled to the control logic 1572, 1582. Legacy I/O devices 1515 are coupled to the chipset 1590.

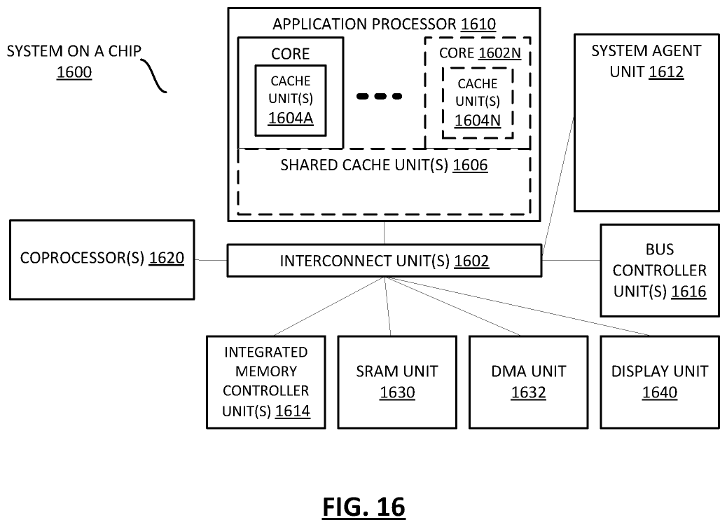

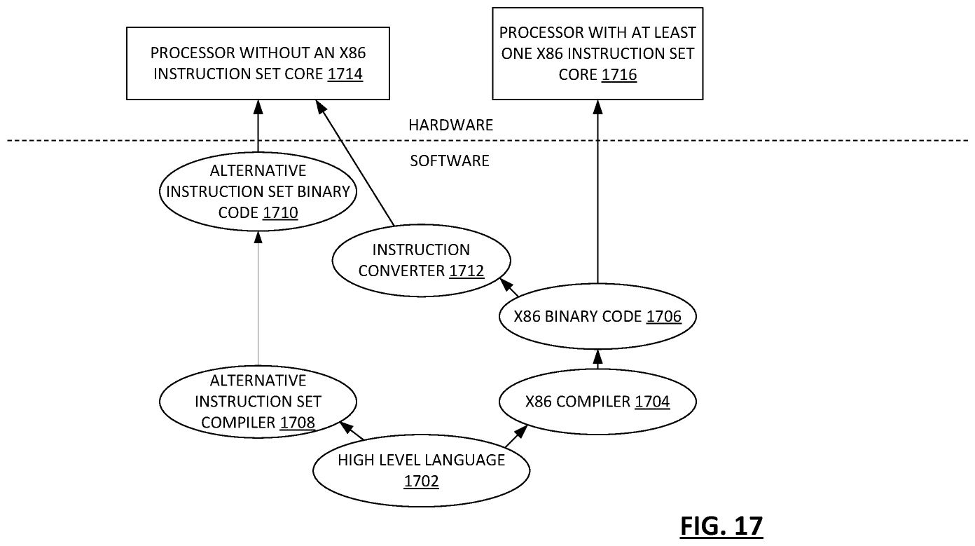

Referring now to FIG. 16, shown is a block diagram of a SoC 1600 in accordance with an embodiment of the present invention. Also, dashed lined boxes are optional features on more advanced SoCs. In FIG. 16, an interconnect unit(s) 1602 is coupled to: an application processor 1610 which includes a set of one or more cores 1620A-N and shared cache unit(s) 1606; a system agent unit 1612; a bus controller unit(s) 1616; an integrated memory controller unit(s) 1614; a set or one or more coprocessors 1620 which may include integrated graphics logic, an image processor, an audio processor, and a video processor; an static random access memory (SRAM) unit 1630; a direct memory access (DMA) unit 1632; and a display unit 1640 for coupling to one or more external displays. In one embodiment, the coprocessor(s) 1620 include a special-purpose processor, such as, for example, a network or communication processor, compression engine, GPGPU, a high-throughput MIC processor, embedded processor, or the like.

Embodiments of the mechanisms disclosed herein may be implemented in hardware, software, firmware, or a combination of such implementation approaches. Embodiments of the invention may be implemented as computer programs or program code executing on programmable systems comprising at least one processor, a storage system (including volatile and non-volatile memory and/or storage elements), at least one input device, and at least one output device.

Program code, such as code 1630 illustrated in FIG. 16, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

FIG. 17 is a block diagram contrasting the use of a software instruction converter to convert binary instructions in a source instruction set to binary instructions in a target instruction set according to embodiments of the invention. In the illustrated embodiment, the instruction converter is a software instruction converter, although alternatively the instruction converter may be implemented in software, firmware, hardware, or various combinations thereof. FIG. 17 shows a program in a high level language 1702 may be compiled using an x86 compiler 1704 to generate x86 binary code 1706 that may be natively executed by a processor with at least one x86 instruction set core 1716. The processor with at least one x86 instruction set core 1716 represents any processor that can perform substantially the same functions as an Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. The x86 compiler 1704 represents a compiler that is operable to generate x86 binary code 1706 (e.g., object code) that can, with or without additional linkage processing, be executed on the processor with at least one x86 instruction set core 1716. Similarly, FIG. 17 shows the program in the high level language 1702 may be compiled using an alternative instruction set compiler 1708 to generate alternative instruction set binary code 1710 that may be natively executed by a processor without at least one x86 instruction set core 1714 (e.g., a processor with cores that execute the MIPS instruction set of MIPS Technologies of Sunnyvale, Calif. and/or that execute the ARM instruction set of ARM Holdings of Sunnyvale, Calif.). The instruction converter 1712 is used to convert the x86 binary code 1706 into code that may be natively executed by the processor without an x86 instruction set core 1714. This converted code is not likely to be the same as the alternative instruction set binary code 1710 because an instruction converter capable of this is difficult to make; however, the converted code will accomplish the general operation and be made up of instructions from the alternative instruction set. Thus, the instruction converter 1712 represents software, firmware, hardware, or a combination thereof that, through emulation, simulation or any other process, allows a processor or other electronic device that does not have an x86 instruction set processor or core to execute the x86 binary code 1706.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the invention also include non-transitory, tangible machine-readable media containing instructions or containing design data, such as Hardware Description Language (HDL), which defines structures, circuits, apparatuses, processors and/or system features described herein. Such embodiments may also be referred to as program products.

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

FIG. 19 is a block diagram contrasting the use of a software instruction converter to convert binary instructions in a source instruction set to binary instructions in a target instruction set according to embodiments of the invention. In the illustrated embodiment, the instruction converter is a software instruction converter, although alternatively the instruction converter may be implemented in software, firmware, hardware, or various combinations thereof. FIG. 19 shows a program in a high level language 1902 may be compiled using an x86 compiler 1904 to generate x86 binary code 1906 that may be natively executed by a processor with at least one x86 instruction set core 1916. The processor with at least one x86 instruction set core 1916 represents any processor that can perform substantially the same functions as an Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. The x86 compiler 1904 represents a compiler that is operable to generate x86 binary code 1906 (e.g., object code) that can, with or without additional linkage processing, be executed on the processor with at least one x86 instruction set core 1916. Similarly, FIG. 19 shows the program in the high level language 1902 may be compiled using an alternative instruction set compiler 1908 to generate alternative instruction set binary code 1910 that may be natively executed by a processor without at least one x86 instruction set core 1914 (e.g., a processor with cores that execute the MIPS instruction set of MIPS Technologies of Sunnyvale, Calif. and/or that execute the ARM instruction set of ARM Holdings of Sunnyvale, Calif.). The instruction converter 1912 is used to convert the x86 binary code 1906 into code that may be natively executed by the processor without an x86 instruction set core 1914. This converted code is not likely to be the same as the alternative instruction set binary code 1910 because an instruction converter capable of this is difficult to make; however, the converted code will accomplish the general operation and be made up of instructions from the alternative instruction set. Thus, the instruction converter 1912 represents software, firmware, hardware, or a combination thereof that, through emulation, simulation or any other process, allows a processor or other electronic device that does not have an x86 instruction set processor or core to execute the x86 binary code 1906.

Although this disclosure has been described in terms of certain implementations and generally associated methods, alterations and permutations of these implementations and methods will be apparent to those skilled in the art. For example, the actions described herein can be performed in a different order than as described and still achieve the desirable results. As one example, the processes depicted in the accompanying figures do not necessarily require the particular order shown, or sequential order, to achieve the desired results. In certain implementations, multitasking and parallel processing may be advantageous. Additionally, other user interface layouts and functionality can be supported. Other variations are within the scope of the following claims.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The following examples pertain to embodiments in accordance with this Specification. Example 1 is an apparatus including: heterogeneous multiplier circuitry including: an interface to a configuration register to access configuration information, where the configuration information identifies respective data formats of a first operand and a second operand to be used in a first multiplication operation, where the first operand is in a first data format including a first numerical representation and the second operand is in a different, second data format including a different, second numerical representation; an operand modifier to modify the second operand to generate a modified second operand; and a multiplier to perform multiplication of the first operand and the modified second operand to generate a result in the first data format.

Example 2 may include the subject matter of example 1, where the multiplier includes floating point multiplier circuitry.

Example 3 may include the subject matter of example 2, where the first numerical representation includes a floating point numerical representation and the second numerical representation includes a fixed-point numerical representation.

Example 4 may include the subject matter of example 3, where the second numerical representation includes an integer.

Example 5 may include the subject matter of example 3, where modifying the second operand includes determining an exponent value corresponding to the second operand, and the exponent value is used to perform the multiplication.

Example 6 may include the subject matter of example 5, where the exponent value includes a constant.

Example 7 may include the subject matter of any one of examples 1-6, where the operand modifier is to determine that a modification is to be made to the second operand based on the configuration information.

Example 8 may include the subject matter of example 7, where the configuration information identifies that the result of the multiplication operation is to be in the first data format.

Example 9 may include the subject matter of any one of examples 1-8, further including a processor device, where the processor device includes the heterogeneous multiplier circuitry.

Example 10 may include the subject matter of any one of examples 1-9, further including a multiply-accumulate (MAC) unit, where the MAC unit includes the heterogeneous multiplier circuitry.

Example 11 may include the subject matter of example 10, where the MAC unit includes heterogeneous adder circuitry, and the heterogeneous adder circuitry is to accept operands in two different data formats.

Example 12 may include the subject matter of any one of examples 1-11, where second configuration information is to be written to the configuration register corresponding to a second multiplication operation including a third operand and a fourth operand, where each of the third and fourth operands are in the first data format, the modifier determines that no modification is to be made to the third and fourth operands, and the multiplier is to perform the second multiplication operation to multiply the third operand with the fourth operand.

Example 13 may include the subject matter of any one of examples 1-12, where the first numerical representation includes a particular numerical representation type with a first precision level and the second number representation includes the same particular numerical representation type, but with a different second precision level.

Example 14 may include the subject matter of example 13, where the particular numerical representation type includes one of a fixed point numerical representation type or a floating point numerical representation type.

Example 15 may include the subject matter of any one of examples 1-14, where the configuration information is based a definition of a convolution neural network including a plurality of layers, and the first multiplication operation is to be performed in association with a particular one of the plurality of layers.

Example 16 may include the subject matter of example 15, where the configuration information is to be updated for a second multiplication operation to be performed in association with another one of the plurality of layers, and a combination of data formats of the operands multiplied in the second multiplication operation are different from the combination of the first data format and second data format.

Example 17 may include the subject matter of example 15, where the first operand includes sample data, and the second operand includes kernel data.

Example 18 is a non-transitory, machine accessible storage medium having instructions stored thereon, where the instructions when executed on a machine, cause the machine to: identify data including a definition of a convolutional neural network including a plurality of layers; identify, from the definition, that a multiplication operation corresponding to a particular one of the plurality of layers is to utilize a first operand in a first data format and a second operand in a different, second data format; and enter configuration information into a register associated with a heterogeneous multiplier circuitry, where the configuration information identifies that the first operand is in a first data format, the second operand is in a second data format, and a result from multiplying the first operand with the second operand is to be in the first data format, where the heterogeneous multiplier circuitry is to support multiplication operations involving operands of different types, and the configuration information is to cause the heterogeneous multiplier circuitry to perform the multiplication operation based on the result being in the first data format.

Example 19 may include the subject matter of example 18, where the first data format includes a first numerical representation and the second data format includes a different, second numerical representation.

Example 20 may include the subject matter of example 19, where the first numerical representation includes a floating point numerical representation and the second numerical representation includes a fixed-point numerical representation.

Example 21 may include the subject matter of example 20, where the second numerical representation includes an integer.

Example 22 may include the subject matter of any one of examples 18-21, where the heterogeneous multiplier circuitry is included within a processor device.

Example 23 may include the subject matter of any one of examples 18-21, where the heterogeneous multiplier circuitry is included within a multiply-accumulate (MAC) unit.

Example 24 may include the subject matter of example 23, where the MAC unit includes heterogeneous adder circuitry, and the heterogeneous adder circuitry is to accept operands in two different data formats.

Example 25 may include the subject matter of example 24, where the configuration information includes configuration for the adder circuitry to identify the two different data formats of operands of the adder circuitry.

Example 26 may include the subject matter of any one of examples 18-25, where the multiplication operation includes a first multiplication operation and the instructions, when executed, further cause the machine to: write second configuration information to the register corresponding to a second multiplication operation including a third operand and a fourth operand, where each of the third and fourth operands are in the first data format; and cause the heterogeneous multiplier circuitry to perform the second multiplication operation to multiply the third operand with the fourth operand.

Example 27 may include the subject matter of any one of examples 18-26, where the first numerical representation includes a particular numerical representation type with a first precision level and the second number representation includes the same particular numerical representation type, but with a different second precision level.

Example 28 may include the subject matter of example 27, where the particular numerical representation type includes one of a fixed point numerical representation type or a floating point numerical representation type.

Example 29 may include the subject matter of example 18, where the multiplication operation includes a first multiplication operation and the instructions, when executed, further cause the machine to update the configuration information for a second multiplication operation to be performed in association with another one of the plurality of layers, and a combination of data formats of the operands multiplied in the second multiplication operation are different from the combination of the first data format and second data format.

Example 30 may include the subject matter of example 29, where the second multiplication operation corresponds to another layer in the plurality of layers.

Example 31 may include the subject matter of any one of examples 18-30, where the first operand includes sample data, and the second operand includes kernel data.

Example 32 may include the subject matter of any one of examples 18-31, where the multiplication operation is performed as part of a convolution operation.

Example 33 is a method including: identifying data including a definition of a convolutional neural network including a plurality of layers; identifying, from the definition, that a multiplication operation corresponding to a particular one of the plurality of layers is to utilize a first operand in a first data format and a second operand in a different, second data format; and entering configuration information into a register associated with a heterogeneous multiplier circuitry, where the configuration information identifies that the first operand is in a first data format, the second operand is in a second data format, and a result from multiplying the first operand with the second operand is to be in the first data format, where the heterogeneous multiplier circuitry is to support multiplication operations involving operands of different types, and the configuration information is to cause the heterogeneous multiplier circuitry to perform the multiplication operation based on the result being in the first data format.

Example 34 may include the subject matter of example 33, where the first data format includes a first numerical representation and the second data format includes a different, second numerical representation.

Example 35 may include the subject matter of example 34, where the first numerical representation includes a floating point numerical representation and the second numerical representation includes a fixed-point numerical representation.

Example 36 may include the subject matter of example 35, where the second numerical representation includes an integer.

Example 37 may include the subject matter of any one of examples 33-36, where the heterogeneous multiplier circuitry is included within a processor device.

Example 38 may include the subject matter of any one of examples 33-37, where the heterogeneous multiplier circuitry is included within a multiply-accumulate (MAC) unit.

Example 39 may include the subject matter of example 38, where the MAC unit includes heterogeneous adder circuitry, and the heterogeneous adder circuitry is to accept operands in two different data formats.

Example 40 may include the subject matter of example 39, where the configuration information includes configuration for the adder circuitry to identify the two different data formats of operands of the adder circuitry.

Example 41 may include the subject matter of any one of examples 33-40, where the multiplication operation includes a first multiplication operation and the method further including: writing second configuration information to the register corresponding to a second multiplication operation including a third operand and a fourth operand, where each of the third and fourth operands are in the first data format; and causing the heterogeneous multiplier circuitry to perform the second multiplication operation to multiply the third operand with the fourth operand.

Example 42 may include the subject matter of any one of examples 33-41, where the first numerical representation includes a particular numerical representation type with a first precision level and the second number representation includes the same particular numerical representation type, but with a different second precision level.

Example 43 may include the subject matter of example 42, where the particular numerical representation type includes one of a fixed point numerical representation type or a floating point numerical representation type.

Example 44 may include the subject matter of example 33, where the multiplication operation includes a first multiplication operation and the method further includes updating the configuration information for a second multiplication operation to be performed in association with another one of the plurality of layers, and a combination of data formats of the operands multiplied in the second multiplication operation are different from the combination of the first data format and second data format.

Example 45 may include the subject matter of example 44, where the second multiplication operation corresponds to another layer in the plurality of layers.

Example 46 may include the subject matter of any one of examples 33-45, where the first operand includes sample data, and the second operand includes kernel data.

Example 47 may include the subject matter of any one of examples 33-46, where the multiplication operation is performed as part of a convolution operation.

Example 48 is a system including computer memory; a processor device including heterogeneous multiplier circuitry and a controller to provide a first operand and a second operand from the computer memory to the heterogeneous multiplier circuitry for multiplication in a first multiplication operation, where the first data format includes a first numerical representation and the second data format includes a different, second numerical representation; and cause the heterogeneous multiplier circuitry to perform the first multiplication operation. The heterogeneous multiplier circuitry includes logic to identify the respective data formats of the first and second operands; modify the second operand to generate a modified second operand; and multiply the first operand with the modified second operand to generate a result of the first multiplication operation in the first data format.

Example 49 may include the subject matter of example 48, including a software manager to: access data defining a convolutional neural network including a plurality of layers; and identify, for one or more of the plurality of layers, respective data formats of operands to be used in a respective multiplication operation associated with the corresponding layer.

Example 50 may include the subject matter of example 49, further including a register associated with the heterogeneous multiplier circuitry, where the software manager is to populate the register with an identification that the first operand in the first multiplication operation includes the first data format and the second operand in the first multiplication operation includes the second data format.

Example 51 may include the subject matter of example 49, where the first multiplication operation is performed in connection with a convolution operation.

Example 52 may include the subject matter of example 51, where the first operand includes a value in a first matrix representing a sample image and the second operand includes a value in a second matrix representing a kernel.

Example 53 may include the subject matter of any one of examples 48-54, where the processor device further includes a multiply-accumulate (MAC) unit including the heterogeneous multiplier circuitry.

Example 54 may include the subject matter of example 53, where the processor device includes a single instruction, multiple data (SIMD) processor device including a plurality of MAC units and each of the plurality of MAC units includes a respective instance of the heterogeneous multiplier circuitry.

Example 55 may include the subject matter of example 53, where the MAC unit further includes heterogeneous adder circuitry.

Example 56 is a system including means to perform the method of any one of examples 33-47.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results.

1.-25. (canceled)

26. An apparatus comprising:
a heterogeneous multiplier circuitry comprising:
an interface to a configuration register to access configuration information, wherein the configuration information identifies respective data formats of a first operand and a second operand to be used in a first multiplication operation, wherein the first operand is in a first data format comprising a first numerical representation and the second operand is in a different, second data format comprising a different, second numerical representation;
an operand modifier to modify the second operand to generate a modified second operand; and
a multiplier to perform multiplication of the first operand and the modified second operand to generate a result in the first data format.

27. The apparatus of claim 26, wherein the multiplier comprises floating point multiplier circuitry.

28. The apparatus of claim 27, wherein the first numerical representation comprises a floating point numerical representation and the second numerical representation comprises a fixed-point numerical representation.

29. The apparatus of claim 28, wherein the second numerical representation comprises an integer.

30. The apparatus of claim 28, wherein modifying the second operand comprises determining an exponent value corresponding to the second operand, and the exponent value is used to perform the multiplication.

31. The apparatus of claim 30, wherein the exponent value comprises a constant.

32. The apparatus of claim 26, wherein the operand modifier is to determine that a modification is to be made to the second operand based on the configuration information.

33. The apparatus of claim 32, wherein the configuration information identifies that the result of the multiplication operation is to be in the first data format.

34. The apparatus of claim 26, further comprising a processor device, wherein the processor device comprises the heterogeneous multiplier circuitry.

35. The apparatus of claim 26, further comprising a multiply-accumulate (MAC) unit, wherein the MAC unit comprises the heterogeneous multiplier circuitry.

36. The apparatus of claim 35, wherein the MAC unit comprises heterogeneous adder circuitry, and the heterogeneous adder circuitry is to accept operands in two different data formats.

37. The apparatus of claim 26, wherein second configuration information is to be written to the configuration register corresponding to a second multiplication operation comprising a third operand and a fourth operand, wherein each of the third and fourth operands are in the first data format, the modifier determines that no modification is to be made to the third and fourth operands, and the multiplier is to perform the second multiplication operation to multiply the third operand with the fourth operand.

38. The apparatus of claim 26, wherein the first numerical representation comprises a particular numerical representation type with a first precision level and the second number representation comprises the same particular numerical representation type, but with a different second precision level.

39. The apparatus of claim 38, wherein the particular numerical representation type comprises one of a fixed point numerical representation type or a floating point numerical representation type.

40. The apparatus of claim 26 wherein the configuration information is based a definition of a convolution neural network comprising a plurality of layers, and the first multiplication operation is to be performed in association with a particular one of the plurality of layers.

41. The apparatus of claim 40, wherein the configuration information is to be updated for a second multiplication operation to be performed in association with another one of the plurality of layers, and a combination of data formats of the operands multiplied in the second multiplication operation are different from the combination of the first data format and second data format.

42. The apparatus of claim 40, wherein the first operand comprises sample data, and the second operand comprises kernel data.

43. At least one machine accessible storage medium having instructions stored thereon, wherein the instructions when executed on a machine, cause the machine to:
identify data comprising a definition of a convolutional neural network comprising a plurality of layers;
identify, from the definition, that a multiplication operation corresponding to a particular one of the plurality of layers is to utilize a first operand in a first data format and a second operand in a different, second data format; and
enter configuration information into a register associated with a heterogeneous multiplier circuitry, wherein the configuration information identifies that the first operand is in a first data format, the second operand is in a second data format, and a result from multiplying the first operand with the second operand is to be in the first data format,
wherein the heterogeneous multiplier is to support multiplication operations involving operands of different types, and the configuration information is to cause the heterogeneous multiplier circuitry to perform the multiplication operation based on the result being in the first data format.

44. A system comprising:
computer memory;
a processor device comprising:
heterogeneous multiplier circuitry; and
a controller to:
provide a first operand and a second operand from the computer memory to the heterogeneous multiplier circuitry for multiplication in a first multiplication operation, wherein the first data format comprises a first numerical representation and the second data format comprises a different, second numerical representation; and
cause the heterogeneous multiplier circuitry to perform the first multiplication operation,
wherein the heterogeneous multiplier circuitry comprises logic to:
identify the respective data formats of the first and second operands;
modify the second operand to generate a modified second operand; and
multiply the first operand with the modified second operand to generate a result of the first multiplication operation in the first data format.

45. The system of claim 44, comprising a software manager to:
access data defining a convolutional neural network comprising a plurality of layers; and
identify, for one or more of the plurality of layers, respective data formats of operands to be used in a respective multiplication operation associated with the corresponding layer.

46. The system of claim 45, further comprising a register associated with the heterogeneous multiplier circuitry, wherein the software manager is to populate the register with an identification that the first operand in the first multiplication operation comprises the first data format and the second operand in the first multiplication operation comprises the second data format.

47. The system of claim 44, wherein the first multiplication operation is performed in connection with a convolution operation.

48. The system of claim 47, wherein the first operand comprises a value in a first matrix representing a sample image and the second operand comprises a value in a second matrix representing a kernel.

49. The system of claim 44, wherein the processor device further comprises a multiply-accumulate (MAC) unit comprising the heterogeneous multiplier circuitry.

50. The system of claim 49, wherein the processor device comprises a single instruction, multiple data (SIMD) processor device comprising a plurality of MAC units and each of the plurality of MAC units comprises a respective instance of the heterogeneous multiplier circuitry.
